(19) United States
(12) Patent Application Publication
(10) Pub. No.: US 2024/0243673 A1
(43) Pub. Date: Jul. 18, 2024

(54) DRIVE DEVICE, DRIVE MOTOR AND METHOD FOR DRIVING A SPINDLE

(71) Applicant: PHYSIK INSTRUMENTE (PI) GMBH & CO. KG, Karlsruhe (DE)

(72) Inventors: Burhanettin KOC, Ettlingen (DE); Reinhard HÜBNER, Waldbronn (DE); Simon KAPELKE, Karlsruhe (DE); Hansjörg LUCKERT-MC BEATH, Karlsruhe (DE)

(21) Appl. No.: 18/564,261

(22) PCT Filed: May 27, 2022
(86) PCT No.: PCT/EP22/64482

§ 371 Date: Nov. 27, 2023

(30) Foreign Application Priority Data
May 27, 2021 (DE) 10 2021 113 751.9

(51) Int. Cl. H02N 2/14; H02N 2/10

(52) U.S. Cl. CPC H02N 2/142; H02N 2/101

(57) ABSTRACT

Drive device (1) for driving a spindle (90) with a spindle axis A90, which is accommodated in a spindle space (39) extending along a longitudinal axis of the spindle space, the drive device (2) comprising a first actuator device (10, 210) and a second actuator device (20, 220) which can be reversibly varied when actuated along a first actuator axis L₁ or a second actuator axis L₂, an actuating device (40, 140, 240), a frame device (30, 130, 230), the arrangement comprising the frame device (30, 130, 230) and the actuating device (40, 140, 240) comprising at least two contact surface sections (51, 52, 151, 152, 254, 264) provided for contact with two different contact areas (91, 92) of the spindle (90) to rotate the spindle (90), wherein the frame device (30, 130, 230) is designed as a structurally continuous component which completely surrounds the spindle space (39), the first actuator device (10) and the second actuator device (20), drive motor and method for driving a spindle (90).

The invention relates to a drive device, a drive motor and a method for driving a spindle.

A drive device with two actuators is known from CN 106208806A.

An object of the invention is to provide a drive device designed as an alternative to known drive devices and a motor with such a drive device, which is advantageous in terms of accuracy and also in terms of manufacture and assembly.

This object is solved with the features of the independent claims. Further embodiments are given in the subclaims referring back to these.

According to the invention, a drive device is provided for driving a spindle with a spindle axis A90 by actuating the drive device (1). The drive device (1) according to the invention comprises:
a spindle space (39) for receiving a portion of the spindle (90) extending in a longitudinal axis of the spindle space,
a first actuator device (10, 210) with a first end (11), with a second end (12) and with a first actuator (13), the extension of which can be reversibly varied when actuated along a first actuator axis L1, wherein the first end (11) and the second end (12) are oriented in opposite directions to one another with respect to the first actuator axis L₁ and wherein the first actuator axis L₁ extends transversely to the spindle axis A90 of a spindle (90),
a second actuator device (20, 220) with a first end (21), with a second end (22) and with a second actuator (23), the extension of which can be reversibly changed along a second actuator axis L₂ when actuated, wherein the first end (21) and the second end (22) are oriented in opposite directions to one another with respect to the second actuator axis L₂ and wherein the first actuator axis L₁ and the second actuator axis L₂ extend along one another, wherein either the first ends (11, 21) or the second ends (21, 22) are actuating ends and the respective other ends of the actuator devices (10, 210, 20, 220) are reference ends,
a frame device (30, 130, 230),
wherein either the frame device (30, 130, 230) or an actuating device (40, 140, 240) of the drive device (1) is fixed to both actuating ends of the actuator devices (10, 20, 210, 220), and in particular is fixed in a rotationally fixed manner, and in each case comprises at least one actuating component (131, 132, 133, 255, 265) which in each case extends cantilevered over its entire length between the actuating ends or from the actuating ends of the actuator devices (10, 210, 20, 220) and comprises a contact surface section (152, 254, 264) which in each case extends at least in a section along the direction of the first actuator axis L₁ or the second actuator axis L₂, delimits the spindle space (39) in one section and is provided for contact with a respective spindle surface contact area (91, 92) of the spindle (90) in order to set the spindle (90) in rotation when the first actuator device (10, 210) or the second actuator device (20, 220) or both actuator devices (10, 210, 20, 220) are operated, wherein the compliance of the actuating component (131, 132, 133, 255, 265) is set such that, if a portion of the spindle (90) is located in the spindle space, the expansion or contraction of at least one actuator device causes a component of movement of the at least one contact surface section along the actuator axes (L1, L2).

According to the invention, the first actuator device and the second actuator device are generally arranged or mounted on the frame device.

The drive device according to the invention can additionally be realized with otherwise any other feature provided according to the invention in a combination of features described herein in such a way that either the first ends or the second ends of the actuator devices are each actuating ends and the respective other ends of the actuator devices are each reference ends, which are fixed at a constant distance from one another when the drive device is actuated. In these embodiments, it can be provided in particular that the reference ends are fixed in a rotationally fixed manner at a constant distance from one another when the drive device is actuated.

The drive device according to the invention can comprise independently of this:
a first actuator device with a first end, with a second end and with a first actuator, the extension of which can be reversibly varied along a first actuator axis L₁ when actuated, preferably electrically, wherein the first end and the second end are oriented in opposite directions to one another with respect to the first actuator axis L₁ and wherein the first actuator axis L₁ extends transversely to the spindle axis A90 of a spindle,
a second actuator device with a first end, with a second end and with a second actuator, the extension of which can be reversibly varied along a second actuator axis L₂ when actuated, preferably electrically, wherein the first end and the second end are oriented in opposite directions to one another with respect to the first actuator axis L₁ and wherein the first actuator axis L₁ and the second actuator axis L₂ extend along one another,
an actuating device, and
a frame device.

In any embodiment of the drive device according to the invention, it can be provided that the arrangement comprising the frame device and the actuating device comprises at least two contact surface sections, which each extend at least in a section along the direction of the first actuator axis L₁ or the second actuator axis L₂ and, viewed in the direction of the spindle axis A90, form different surface areas from one another, which are provided for contact with a spindle at two different contact areas in order to set the spindle in rotation when the first and second actuator devices are operated.

In any embodiment of the drive device according to the invention, it may be provided that the first and the second actuator device each with the first end contact the frame device and with the second end contact the actuating device, and wherein the frame device is designed as a structurally continuous component which completely surrounds the spindle chamber, the first actuator device and the second actuator device in the circumferential direction defined by the spindle axis A90. The drive device according to the invention, which comprises the arrangement comprising the frame device and the actuating device with at least two contact surface sections, can additionally be realized with otherwise any other feature provided according to the invention in a combination of features described herein in each case in such a way that the arrangement comprising the frame device (30, 130, 230) and the actuating device (40, 140, 240) comprises at least one actuating component (131, 132, 133, 255, 265) with an contact surface section (51, 52, 151, 152, 254, 264), the actuating component (131, 132, 133, 255, 265) being fixed in each case to the actuating ends of the actuator devices (10, 210, 20, 220) and extends cantilevered therefrom in each case over its entire extension between the respective actuating ends or from respective actuating ends of the actuator devices (10, 210, 20, 220), the compliance of the actuating component (131, 132, 133, 255, 265) being set such that, if a section of the spindle (90) is located in the spindle space, the actuating component (131, 132, 133, 255, 265) is resiliently biased against the spindle and the expansion or contraction of at least one actuator device causes a movement component of the at least one contact surface section along the actuator axes (L₁, L₂) and in particular along the circumferential direction of a spindle inserted into the spindle space.

The drive device according to the invention can additionally be realized with otherwise any other feature provided according to the invention in a combination of features described herein in such a way that the actuator devices each comprise a piezo actuator.

In each embodiment of the drive device according to the invention, which comprises two contact surface sections, in particular of the actuating component structure, it can be provided that the at least two contact surface sections are located opposite one another as viewed in the direction of the spindle chamber longitudinal axis.

In any embodiment of the drive device according to the invention, it can be provided that the at least two contact surface sections are concavely curved as seen from the spindle space and the curvature is formed along the circumferential direction defined with respect to the longitudinal axis of the spindle space or a spindle axis and is designed so that it lies flat against a circumferential section of a section of a spindle located in the longitudinal axis of the spindle space.

In any embodiment of the drive device according to the invention, it can be provided that the arrangement comprising the frame device and the actuating device resiliently pretension the first actuator device along the first actuator axis L₁ and the second actuator device along the second actuator axis L₂ and thereby provide a resilient pretensioning of the actuating device in the direction of the spindle space.

The drive device according to the invention can additionally be realized with otherwise any other feature provided according to the invention in a combination of features described herein in such a way that the arrangement of the frame device (30, 130, 230) and the actuating device (40, 140, 240) comprises at least two contact surface sections (51, 52, 151, 152, 254, 264), which each extend at least in a section along the direction of the first actuator axis L₁ or the second actuator axis L₂ and, viewed in the direction of the longitudinal axis of the spindle chamber, form surface areas which are located differently from one another and which are intended for contact with two different contact areas (91, 92) of the spindle (90) in order to set the spindle (90) in rotation when the first and second actuator devices (10, 20) are operated, the first and second actuator devices (10, 20, 210, 220) each comprising a first end (11, 21) connected to the frame device (30, 130, 230) and a second end (12, 22) connected to the actuating device (40, 140, 240) or an actuating piece (141) and wherein the frame device (30, 130, 230) is designed as a structurally continuous component which completely surrounds the spindle chamber (39), the first actuator device (10) and the second actuator device (20) in the circumferential direction defined by the longitudinal axis of the spindle chamber.

The drive device according to the invention can additionally be realized with otherwise any other feature provided according to the invention in a combination of features described herein in each case, wherein the at least one contact surface section (152, 254, 264) is a surface section of either an outer layer of the actuating component (131, 132, 133, 255, 265) which is made of a ceramic material or comprises a ceramic material, or of an insert piece which is inserted into the actuating component (131, 132, 133, 255, 265) on an outer side of the actuating component (131, 132, 133, 255, 265) facing the spindle space, or is a surface section of a portion of the actuating component (131, 132, 133, 255, 265) which comprises the contact surface section (152, 254, 264) and is made of a ceramic material or comprises a ceramic material. The embodiments of the drive device comprising a contact surface section (152, 254, 264) which is a surface section of a ceramic material may in particular be realized in such a way that the ceramic material comprises or consists of one or more of the following material components: Alumina ceramic, ZTA (Zirconia Toughened Alumina), ATZ (Alumina Toughened Zirconia).

According to a further aspect of the invention, a drive motor is provided with a drive device according to an embodiment described herein and with a spindle which is accommodated in the spindle chamber of the frame device and whose spindle axis A90 extends transversely to the first actuator axis L₁ or to the second actuator axis L₂,

wherein each of the at least one contact surface section (152, 254, 264) contacts a respective spindle surface contact area (91, 92) of the spindle (90),

wherein the compliance of the actuator component (131, 132, 133, 255, 265) is set such that, due to the contact between each of the contact surface sections (152, 254, 264) and a respective spindle surface contact area (91, 92), the expansion or contraction of at least one actuator device causes a component of movement of the at least one contact surface section along the actuator axes (L₁, L₂).

The drive motor according to the invention can additionally be realized with otherwise any other feature provided according to the invention in a combination of features described herein in such a way that an actuating surface section of the spindle, which comprises the at least one spindle surface contact area (91, 92) of the spindle (90), which is located on the spindle depending on the axial position of the spindle, in particular in the axial movement range of the spindle during its actuation, which is predetermined as maximum, a surface section of either an outer layer of the spindle (90), which is made of a ceramic material, or of an insert piece, which is inserted into the spindle (90) on an outer side of the spindle (90) facing the spindle space, or is a surface section of a section of the spindle (90), which comprises the actuating surface section of the spindle and is made of a ceramic material or comprises a ceramic material.

The embodiments of the drive motor according to the invention, which comprise an actuating surface section which is a surface section of a ceramic material, can additionally be realized with otherwise any other feature provided according to the invention in a feature combination described herein in each case in such a way that the ceramic material comprises or consists of one or more of the following material components: Alumina ceramic, ZTA (Zirconia Toughened Alumina), ATZ (Alumina Toughened Zirconia).

In any embodiment of the drive motor according to the invention, it may be provided that the at least two contact surface sections are resiliently pressed against two different, preferably opposite, contact areas of the spindle.

The drive device according to the invention can additionally be realized with otherwise any other feature provided according to the invention in a combination of features described herein in such a way that the first ends (11, 21) are actuating ends and the respective other ends of the actuator devices (10, 210, 20, 220) are reference ends of the actuator devices (10, 210, 20, 220),

wherein the frame device (30) comprises: two side portions (131, 132) which are fixed to the actuating ends of the first and second actuator devices (10, 20) in a rotationally fixed manner, and a connecting portion (134) which connects the two side portions (131, 132),

wherein the two side sections (131, 132) and the connecting section (134) are realized as an actuating component (131, 132, 133), which in each case extends cantilevered over its entire extent between the actuating ends and comprises a contact surface section (152), which in each case extends at least in a section along the direction of the first actuator axis L₁ or the second actuator axis L₂, delimits the spindle space (39) in one section and is provided for contact with a respective spindle surface contact area (91, 92) of the spindle (90) in order to set the spindle (90) in rotation when the first actuator device (10, 210) or the second actuator device (20, 220) or both actuator devices are operated,

wherein the compliance of the actuating component (131, 132, 133) is set such that, if a portion of the spindle (90) is located in the spindle space, the expansion or contraction of at least one actuator device causes a component of movement of the contact surface section (152) along the actuator axes (L₁, L₂).

These embodiments can be realized in such a way that the two side sections (131, 132) are fixed to the actuating ends of the first and second actuator device (10, 20) in a rotationally fixed manner.

The drive device according to the invention can additionally be realized with otherwise any other feature provided according to the invention in a combination of features described herein in such a way that the reference ends of the actuator devices (10, 210, 20, 220) are fixed at a constant distance from one another, in particular by an intermediate piece located between the reference ends or a component of the frame device, when the actuator devices are operated.

Each embodiment of the drive device according to the invention, which comprises an arrangement comprising the frame device and the actuating device with at least two contact surface sections, can be realized in such a way that the surface areas, seen in the direction of the spindle space longitudinal axis, are different from one another and in particular opposite one another, it can be provided that the drive device or the actuating device comprises an actuating piece or intermediate piece which is located between reference surfaces and in particular is held by these and comprises a first contact surface section which is located facing the spindle space,

wherein the first end of the first actuator device contacts a first actuator surface or first intermediate piece surface and the first end of the second actuator device contacts a second actuator surface or second intermediate piece surface, wherein the first actuator surface or second intermediate piece surface and the second actuator surface or second intermediate piece surface are set at least in a section opposite one another and are oriented along the first actuator axis L₁ and the second actuator axis L₂.

These embodiments of the actuator device can be realized in such a way that the frame device presses the respective second ends of the first and second actuator device against the actuating piece from two opposite sides.

In these embodiments of the drive device, the first actuator surface or intermediate piece surface and the second actuator surface or intermediate piece surface can extend at least in a section transversely to the first actuator axis L₁ and the second actuator axis L₂.

The drive device according to the invention with the intermediate piece can additionally be realized with otherwise any other feature provided according to the invention in a combination of features described herein in such a way that ss the intermediate piece (141) comprises a first contact surface section (151) facing the spindle space (139), which in each case extends at least in a section along the direction of the first actuator axis L₁ or the second actuator axis L₂, delimits the spindle space (139) in one section and is provided for contact with a respective spindle surface contact area (91) of the spindle (90) in order to set the spindle (90) in rotation together with the contact surface section (152) of the connecting section (134) when the first actuator device (10, 210) or the second actuator device (20, 220) or both actuator devices (10, 210, 20, 220) are operated.

The drive device according to the invention with the intermediate piece can additionally be realized with otherwise any other feature provided according to the invention in a feature combination described herein in each case in such a way that each of the at least one contact surface section (151, 152) contacts a respective spindle surface contact area (91, 92) of the spindle (90).

In any embodiment of the drive device according to the invention, in which the arrangement comprising the frame device and the actuating device comprises at least two contact surface sections which, viewed in the direction of the spindle space longitudinal axis, form surface areas which are located differently from one another and the actuating device is designed as an actuating piece, provision can be made,

that the frame device comprises a first side portion, a second side portion extending along the first side portion, a first connecting portion and a second connecting portion, wherein the first connecting portion and the second connecting portion extend along each other and both connect the first side portion and the second side portion, respectively,

that the spindle space is located between the actuating piece and the second connecting section and the second connecting section comprises the contact surface section).

In particular, the contact surface section is suitable in that a circumferential section of the spindle lies flat against it and is concavely curved as seen from the spindle chamber and the curvature is formed in the circumferential direction defined with respect to the spindle axis, in that a surface of the actuating piece facing the spindle chamber comprises a contact surface section, the contact surface sections of the connecting section and actuating piece lying opposite one another with respect to the spindle axis.

According to the invention, there is also provided a drive motor with a drive device according to an embodiment described herein and with a spindle partially located in the spindle space, wherein the arrangement of the frame device and the actuating device comprises at least one contact surface section and each of the at least one contact surface section (151, 152) contacts a respective spindle surface contact area (91, 92) of the spindle (90).

These embodiments of the drive motor can comprise at least two contact surface sections which, viewed in the direction of the longitudinal axis of the spindle space, form surface areas which are located differently from one another, and the actuating device is designed as an actuating piece, and with a spindle with a spindle axis, the spindle being located between the contact surface sections, the arrangement comprising the frame device and the actuating device pressing the contact surface sections against the respective contact areas of the spindle.

The drive device according to the invention can additionally be realized with otherwise any other feature provided according to the invention in a feature combination described herein in each case in such a way that the frame device (230) comprises: a first actuator support part (251), against which the first actuator device (210) bears with its first end (11) as reference end, a second actuator support part (261), against which the second actuator device (220) bears with its first end (21) as reference end,

wherein the drive device (201) comprises: a first actuator functional part (255) with a first actuating section (258), to which the first actuator device (210) is fixed with its second end (12) as actuating end and in particular is fixed in a rotationally fixed manner, a second actuator functional part (265) with a second actuating section (268), to which the second actuator device (220) is fixed in a rotationally fixed manner with its second end (22) as actuating end,

wherein the first actuator functional part (255) is realized as a first actuating component and the second actuator functional part (265) is realized as a second actuating component, wherein the actuating component extends cantilevered over its entire extension from the actuating ends of the actuator devices (210, 220) and comprises a contact surface section (254, 264).

In these embodiments of the drive device, it may be provided that the contact surface sections are each concavely curved from the spindle space. In particular, it may be provided that the curvatures are formed in the circumferential direction defined with respect to the spindle axis and are suitable for each of these to lie flat against the contact areas of a circumferential section of the spindle, with the surface normal directions of points of the first friction surface section in the circumferential direction of the spindle axis lying in an angular range, which contains the direction of the first actuator axis L₁ and the surface normal directions of points of the second friction surface section in the circumferential direction of the spindle axis lie in an angular range which contains the direction of the second actuator axis L₂.

In embodiments of the biasing device according to the invention, in combination with one or more of the other variants or embodiments of the drive device otherwise described or contained herein, it may be provided that the first and second actuating sections extend along each other.

The drive device according to the invention can additionally be realized with otherwise any other feature provided according to the invention in a combination of features described herein in such a way that the first actuator functional part (255) comprises the first actuating section (258) and a first contact portion (257) which is connected to the first actuating section (258), and the second actuator functional part (265) comprises the second actuating section (268) and a second contact section (267) which is connected to the second actuating section (268), wherein the first and second actuating sections (258, 268) extend along each other.

In the embodiments of the drive device according to the invention with actuating sections each with a first contact section, the contact surface sections can each be concavely curved from the spindle space.

The drive device according to the invention can additionally be realized with otherwise any other feature provided according to the invention in a feature combination described herein in such a way that the first and the second actuating section (258, 268) each comprise an outer end section (285, 286) which is located in each case opposite to the first contact section (257) or the second contact section (267), wherein the outer end portion (285) of the first actuating section (258) and the outer end portion (386) of the second actuating section (268) are connected to one another via a coupling section (280), so that the first actuator functional part (255), the second actuator functional part (265) and the coupling section (280) are realized as a one-piece actuating component which extends cantilevered over its entire extension between the actuating ends.

In this regard, according to the invention, there is provided a drive motor comprising a drive device with actuator functional parts and actuator support parts and a spindle with a spindle axis A90 received in the spindle space, the spindle being located between the first contact surface section and the second contact surface section, each of the at least one contact surface section (151, 152) contacting a respective spindle surface contact area (91, 92) of the spindle (90). In these embodiments of the drive motor, it may be provided that the arrangement of the frame device and the actuating device presses the first contact surface section and the second contact surface section against the respective contact areas of the spindle.

According to a further aspect of the invention, a method is provided for driving a spindle with a spindle axis A90 which is accommodated in a spindle space of a drive motor with an embodiment of the drive device according to the invention, wherein the drive device controls the first actuator and the second actuator periodically and in antiphase with a control signal and preferably with an electrical voltage signal, wherein the gradients of a rising flank and a falling flank of the control signal of the same control period comprise different gradients relative to each other.

According to a further aspect of the invention, a method is provided for driving a spindle of a drive motor with a spindle space for receiving the spindle, comprising two actuator devices and comprising an actuating component structure, wherein the actuator devices can actuate the actuating component structure, to drive the spindle according to the stick-slip principle, wherein the actuator devices are each driven by one of two drive signals each comprising a sequence of at least one signal pulse section (SP61, SP62 or SP71, SP72), wherein each signal pulse section comprises:
(a) a respective stick driving section (613, 614, 713, 714), wherein the section with the largest gradient has a gradient which is less than a predetermined maximum stick gradient value, wherein the stick driving sections of the two signal pulse sections taking place simultaneously and in antiphase,
(b) in each case followed by a plateau phase of varying duration,
(c) followed by a respective slip drive section of the two signal pulse sections at different points in time from one another, wherein their respective sections with minimum gradient have a gradient which is less than a predetermined minimum slip gradient value, wherein the stick drive section which had a positive gradient in step (a) comprises a negative gradient in step (c) and wherein the stick drive section which had a negative gradient in step (a) comprises a negative gradient in step (c),
(d) followed by a plateau phase of varying duration up to a simultaneous end point for both signal pulse sections.

According to a further aspect of the invention, a method is provided for driving a spindle (90) with a spindle axis A90, with a drive device (2), wherein the drive device comprises two actuator devices (10, 20, 210, 220), wherein either a frame device (30, 130, 230) or an actuating device (40, 140, 240) of the drive device (1) is fixed to both actuating ends of the actuator devices (10, 20, 210, 220), and in particular is fixed in a rotationally fixed manner, and in each case comprises at least one actuating component (131, 132, 133, 255, 265), which in each case extends cantilevered over its entire length between the actuating ends or from the actuating ends of the actuator devices (10, 210, 20, 220) and comprises a contact surface section (152, 254, 264) which in each case extends at least in a section along the direction of the first actuator axis L₁ or the second actuator axis L₂, delimits the spindle space (39) in one section and is provided for contact with a respective spindle surface contact area (91, 92) of the spindle (90) in order to set the spindle (90) in rotation when the first actuator device (10, 210) or the second actuator device (20, 220) or both actuator devices (10, 210, 20, 220) are operated, wherein the compliance of the actuating component (131, 132, 133, 255, 265) is set such that, if a portion of the spindle (90) is located in the spindle space, the expansion or contraction of at least one actuator device causes a component of movement of the at least one contact surface section along the actuator axes (L₁, L₂),

wherein the drive device (2) periodically controls the first actuator (13) and the second actuator (23) with a control signal, wherein the gradients of a rising flank and a falling flank of the control signal each comprise a half-period of the same control period with gradients which differ according to amount from one another.

According to the invention, an actuator device or an actuator can generally be an electromechanical element. The electromechanical element can be designed as a piezo actuator. Alternatively, it can also be designed as a bulk element.

The term “compliance” is understood here, as is usual in the field of mechanics, as the reciprocal of stiffness. In this sense, “stiffness” is understood to be a quantity that describes the resistance a body or component can apply against deformation caused by an external influence (torque or force). Stiffness depends on two factors: On the geometry of the respective body or a component and on its material. The stiffness can be an elongation, torsion and bending stiffness or a combination of these special stiffnesses.

The term “cantilevered” in relation to a component means herein that this component can fulfill its function without further external elements for load bearing. Thus, this component is a component of the respective drive device according to the invention or of the respective motor according to the invention, which is supported only on one side or on two opposite sections or ends. In particular, the component can be a frame device provided according to the invention or a part of the frame device or an actuator functional part or actuating component provided according to the invention.

The term “along” herein means, in the context of a directional indication mentioned herein, which may in particular also concern the course of a contour line or a surface or a direction of a component or a structural component such as an axis or a shaft or a central axis thereof, in relation to a reference direction or a reference axis, that a section of the course or the tangent to a respective contour line or respective surface or the direction in an explicitly or implicitly predetermined viewing direction deviates locally or in sections with an angle of at most 45 degrees and in particular of at most 30 degrees from the respective reference direction or reference axis to which the respective directional indication is related. reference axis to which the respective directional information is related.

The term “transverse” herein means in the context of a directional indication mentioned herein, which may in particular also concern the course of a contour line or a surface or a direction of a component or a structural component such as an axis or a shaft or a central axis thereof, with respect to a reference direction or a reference axis, that a section of the course or the tangent to a respective contour line or respective surface or the direction in an explicitly or implicitly predetermined viewing direction deviates locally or in sections with an angle which is between 45 degrees and 135 degrees, and preferably with an angle which is between 67 degrees and 113 degrees, from the respective reference direction or reference axis to which the respective contour line or surface or the direction in an explicitly or implicitly predetermined viewing direction is directed. reference axis to which the respective directional information is related.

As used herein, a “distance”, in particular between two objects or two surfaces or reference points, is understood to mean in particular the shortest distance or the shortest distance between the two objects or surfaces or reference points, the shortest distance or the shortest distance being unequal to zero in terms of amount, unless explicitly stated otherwise herein in this respect.

As used herein, the term “fixed” in relation to two component parts and in particular in relation to two contact areas or contact surfaces or reference sides of one of two component parts in each case means that the two component parts and in particular the two contact areas or contact surfaces or reference sides maintain predetermined positions relative to one another, even if external forces act on at least one of the component parts or internal stresses act in at least one of the component parts or at least one of the component parts executes a movement.

As used herein, the term “rotationally fixed” in relation to two component parts and in particular in relation to two contact areas or contact surfaces or reference sides of one of two component parts in each case means that the two component parts and in particular the two contact areas or contact surfaces or reference sides maintain predetermined positions relative to one another, even if external forces or moments or forces and moments act on at least one of the component parts or internal stresses act in at least one of the component parts or at least one of the component parts executes a rotary movement.

A “longitudinal direction” or another reference direction of a reference line, such as in particular a central axis or a centrally extending line or a center line of at least one structural component or a part and in particular of a guideway, results herein in particular as a connecting line of the centers of gravity of the respective smallest cross-sectional areas of the respective structural component along a determined or predetermined direction or between two determined or predetermined ends. In the event that the reference line can be curved or at least partially curved, the reference direction can generally be understood as a local longitudinal direction. However, the reference direction herein can also be understood as the direction of a rectilinearly defined reference line, whereby a line whose position relative to the curved line results in the smallest deviation between these lines or the smallest deviation area is used to determine the rectilinear reference line. The same applies if a straight reference line is to be derived from a curved line.

The term “elongate” in relation to a component and in particular in relation to a leaf spring or leaf spring arrangement is understood herein to mean that a first length of the component, which is obtained in a first longitudinal direction, is at least 1,2 times greater than a second length of the component, which is obtained in a second longitudinal direction which is perpendicular to the first longitudinal direction and the thickness direction. In particular, the first length can be the longest length in terms of amount. The aforementioned lengths can also result in a reference plane, which can in particular be a center plane.

A longitudinal direction of a component can be understood herein in particular as the aforementioned first longitudinal direction and a width direction can be understood herein in particular as the aforementioned second longitudinal direction.

The term “substantially” in relation to a feature or value is understood herein in particular to mean that the feature contains a deviation of 20% and especially of 10% from the feature or its geometric property or value.

A “curved course” of a line or flank or surface means that the surface, viewed along a reference direction, comprises no corner over the entire width running transverse to the reference direction, i.e. comprises a differentiable course.

In this context, “curvature” of a component or a surface of a component along a direction, e.g. along a longitudinal direction, means that the component curves along this direction. The curvature is visible in its course in a viewing direction transverse to this direction and can be visible, for example, along a width direction of the component.

In this context, “orientation” in relation to a surface and, in particular, a surface is understood to mean the normal to the respective surface. In the event that the surface in question is not a straight surface but, for example, a curved surface, the normal to a straight surface of the same size can be used to determine the surface normal, the position of which relative to the curved surface results in the smallest total deviation.

An “extension” of a surface section is understood to be a direction of a planar surface section which runs along the referenced surface section and, in relation to the latter, if the latter comprises curved portions or portions of different orientation, comprises a position such that the sum of the deviation amounts between the two surface sections is minimal. With reference to a length amount of the extension of a surface section, a length of a fictitious surface section of the same size in a direction to be defined is understood herein, which comprises a orientation relative to the referenced surface section at which the sum of the deviation amounts between the two surface sections is minimal.

The term “one-piece” in relation to a part or component is understood herein to mean that the part or component is manufactured as a single piece. The part or component may be formed from several pieces or parts that are connected or coupled or joined together. In this respect, the term “manufactured from one piece” is understood to mean that the part or component is manufactured from a single-piece starting workpiece.

In this context, the term “electromechanical material” refers to a material that undergoes a dimensional change when the material is subjected to a corresponding electrical voltage; for example, an element made of an electromechanical material can undergo a change in length when subjected to voltage.

As used herein, “actuating surface section of the spindle” means a surface section of the spindle which is or can be located in a predetermined maximum axial actuating range or adjustment range of the spindle facing the at least one contact surface section of the frame device or the actuating device and in particular of the actuating component or the actuator functional part due to the actuation of at least one of the actuator devices.

In this context, the logical link “or” in relation to two alternatives is understood to mean only one or the other of the alternatives, unless otherwise specified.

In the following, embodiments of the invention are described with reference to the accompanying figures. Herein, the description of features or components of embodiments according to the invention is to be understood as meaning that a respective embodiment according to the invention, unless this is explicitly excluded, may also comprise at least one feature of another embodiment, in each case as an additional feature of this respective embodiment or as an alternative feature replacing another feature of this respective embodiment. The figures show:

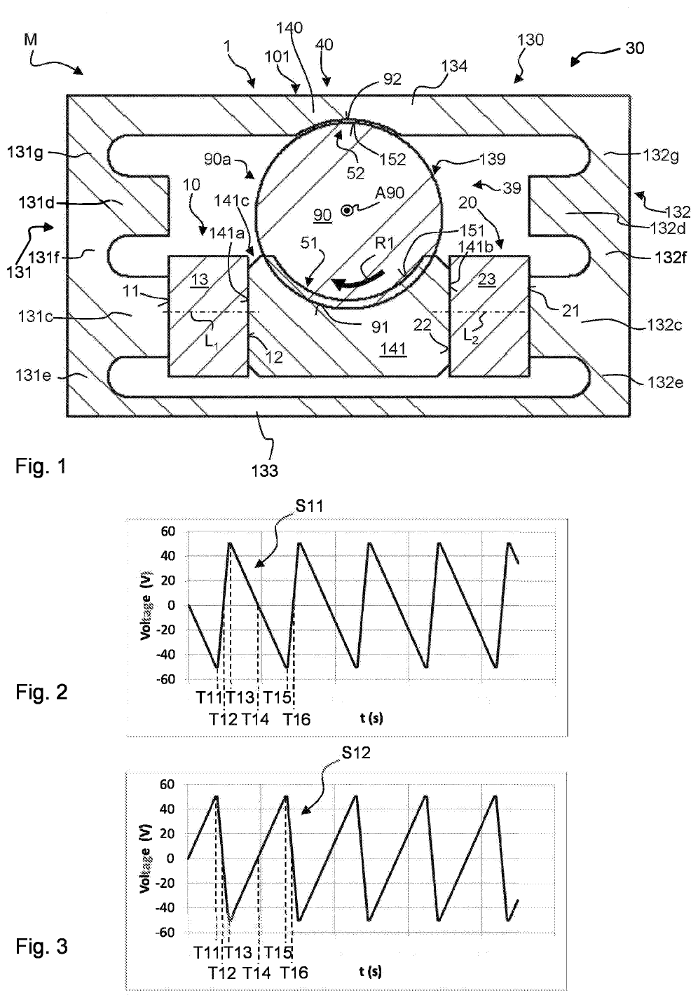

FIG. 1 a sectional view of an embodiment of the drive device according to the invention, which comprises a frame device with a clamping arrangement, a first actuator device with a first actuator, a second actuator device with a second actuator and an actuating part, wherein the actuating part and the frame device are arranged in such a way that they can receive an actuator in the form of a spindle in order to drive it to perform an actuating movement when the actuator devices with contact surface sections are activated, wherein the spindle is also shown, that these can receive an actuator in the form of a spindle in order to drive the latter when the actuator devices with contact surface sections are activated in order to execute an actuating movement, wherein the spindle is also shown, wherein the side representation is in the direction of view of the longitudinal axis of the spindle, and wherein a first actuating direction is shown for the spindle in the form of an arrow,

FIG. 2 is an illustration of an exemplary first electrical control signal for activating the first actuator device of the embodiment of the drive device of FIG. 1,

FIG. 3 an illustration of an exemplary second electrical control signal for activating the second actuator device of the embodiment of the drive device of FIG. 1 with the control signal shown in FIG. 2, wherein the spindle is driven in the first actuating direction shown in FIG. 1 with the first control signal and simultaneously with the second control signal,

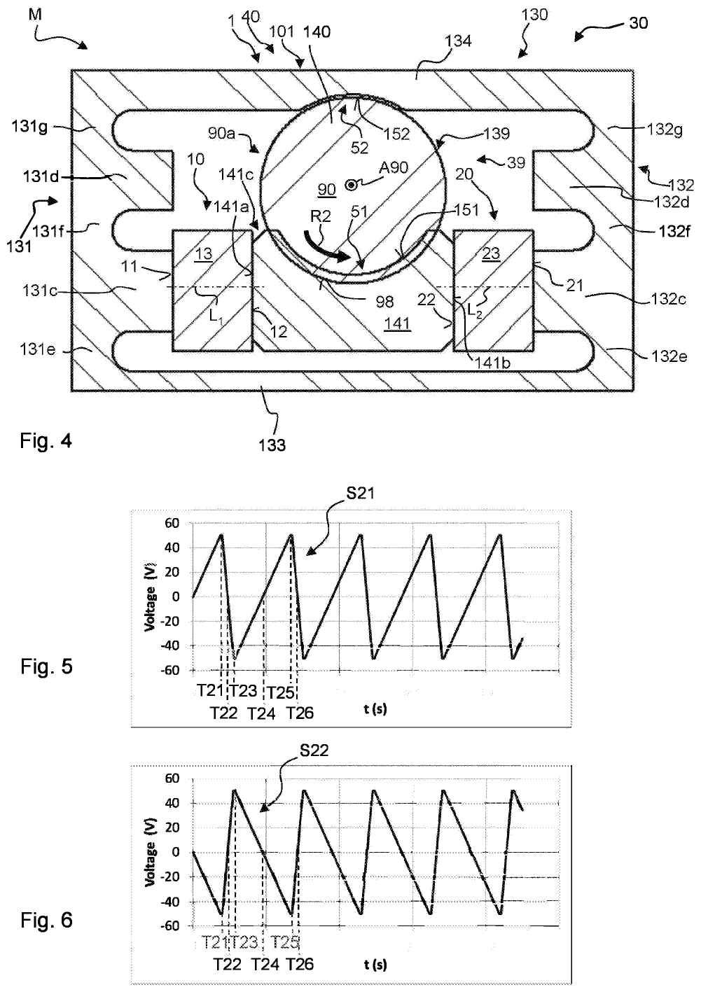

FIG. 4 shows the embodiment of the drive device as shown in FIG. 1, with a second setting direction for the spindle in the form of an arrow, which is directed in the opposite direction to the first setting direction,

FIG. 5 is an illustration of an exemplary further first control signal for activating the first actuator device of the embodiment of the drive device of FIG. 1,

FIG. 6 an illustration of an exemplary further second control signal for activating the second actuator device of the embodiment of the drive device of FIG. 1 with the control signal shown in FIG. 5, wherein with the further first control signal and simultaneously with the further second control signal spindle is driven in the second actuating direction shown in FIG. 4,

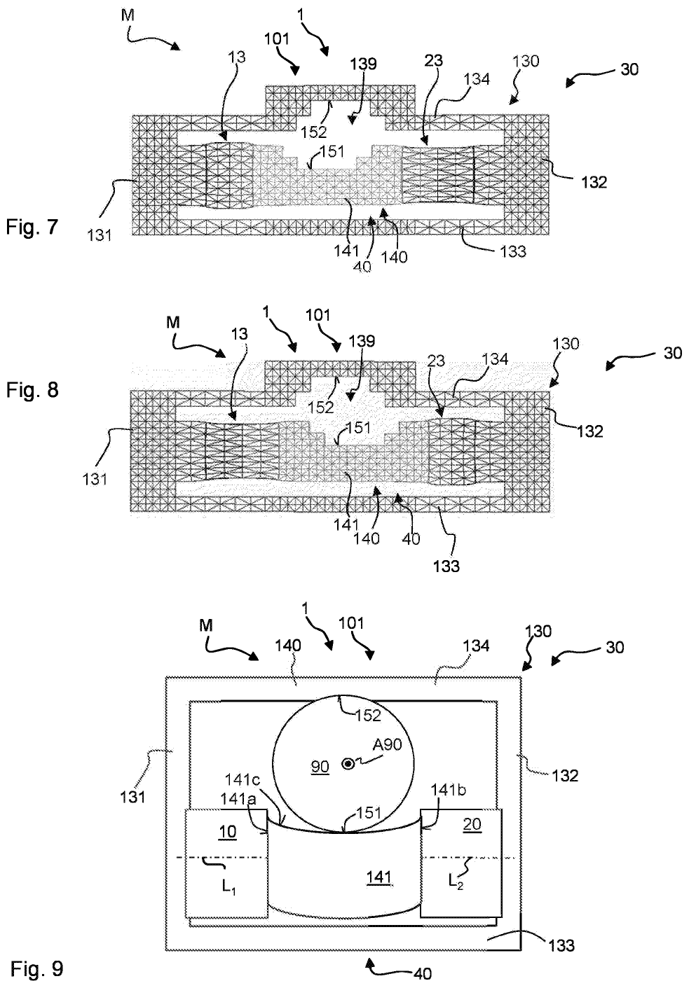

FIG. 7 is a finite element model of the embodiment of the drive device of FIG. 1, showing a simulated or calculated first deformation state of the drive device,

FIG. 8 is a finite element model of the embodiment of the drive device of FIG. 1, showing a simulated or calculated second deformation state of the drive device,

FIG. 9 is a schematic sectional view of a variant of the design of the drive device in FIG. 1,

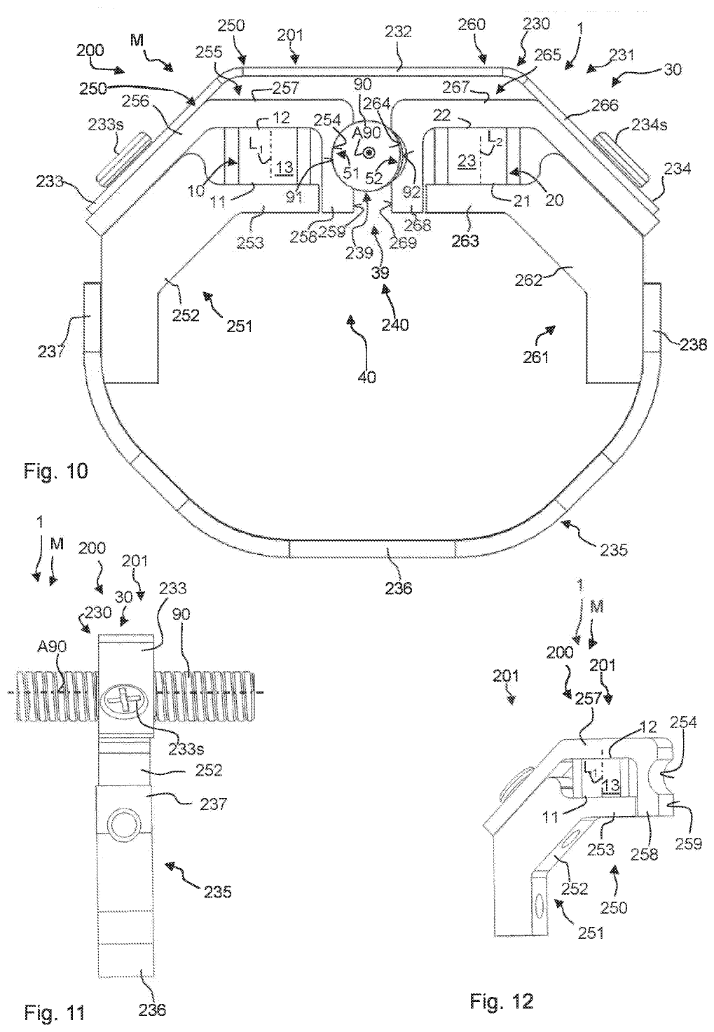

FIG. 10 a first side view of a further embodiment of the drive device according to the invention, which comprises a frame device with a clamping arrangement, which is formed from a first and a second clamping device, a first actuator device, a second actuator device and actuating sections each with a contact surface section, wherein the spindle is also shown and wherein the side view is in the direction of view of the longitudinal axis of the spindle,

FIG. 11 is a second side view of the embodiment of the drive device shown in FIG. 10,

FIG. 12 is a perspective view of the embodiment of the drive device shown in FIG. 10,

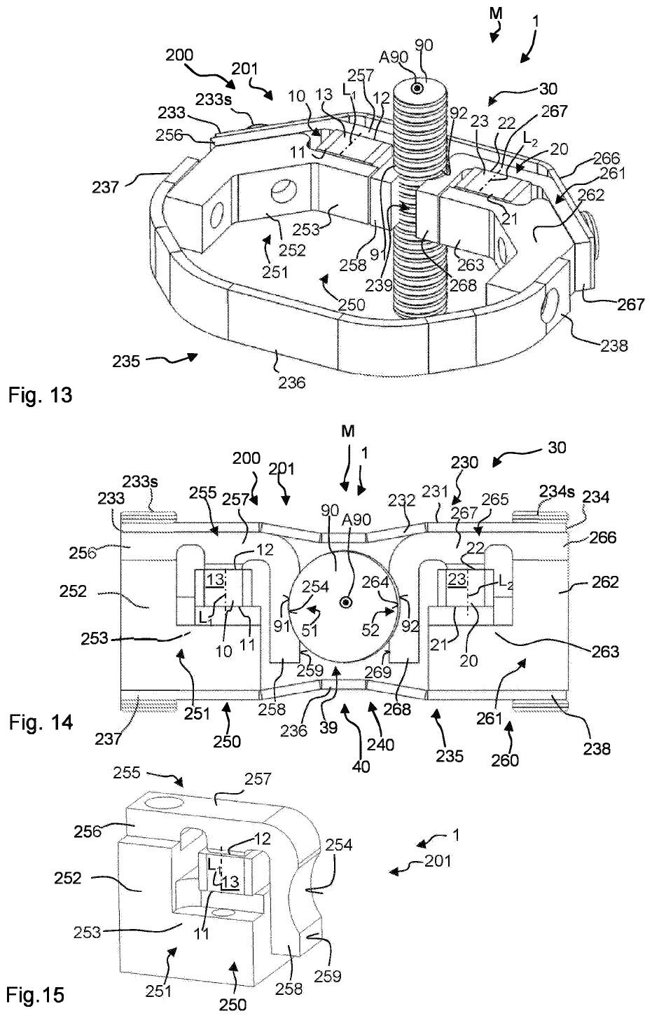

FIG. 13 is a perspective view of the combination of the first clamping device and the first actuator device, wherein the first clamping device is shown in a clamping state in which it clamps the first actuator device,

FIG. 14 a side view of a variant of the design of the drive device of FIG. 10, whereby the side view is in the direction of the longitudinal axis of the spindle,

FIG. 15 a perspective view of a section of the drive device according to FIG. 14 containing the combination of the first clamping device of the drive device of FIG. 14 and the first actuator device, wherein the first clamping device is shown in a clamping state in which it clamps the first actuator device,

FIG. 16 a finite element model of the embodiment of the drive device of FIG. 14, showing a simulated or calculated first deformation state of the drive device,

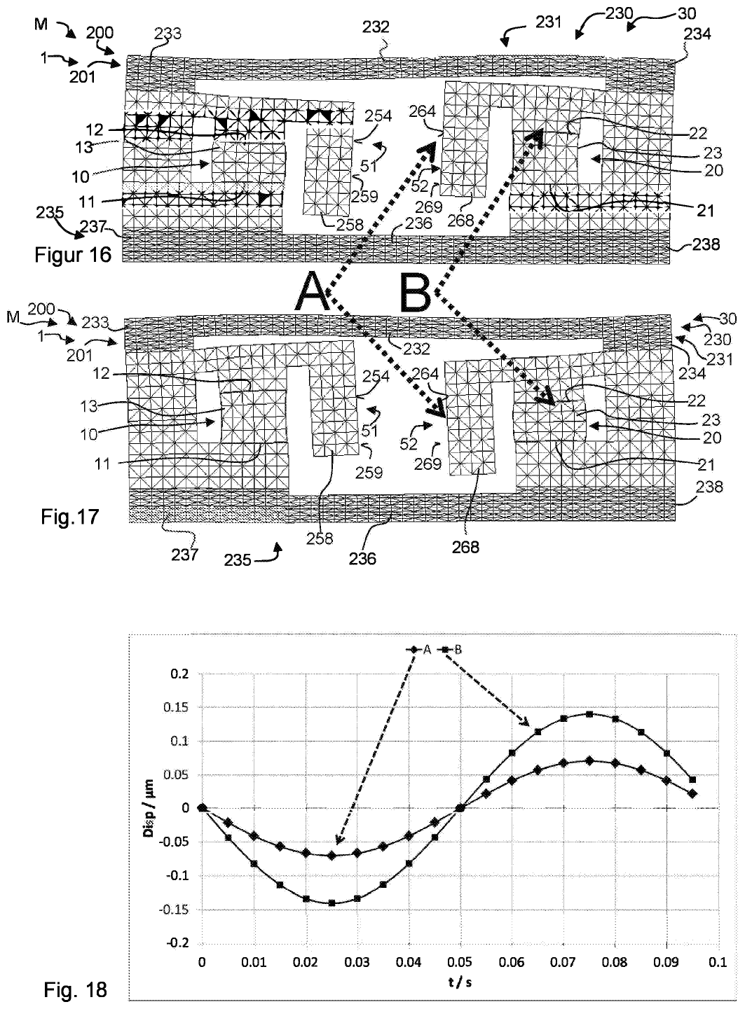

FIG. 17 a finite element model of the embodiment of the drive device of FIG. 14, showing a simulated or calculated second deformation state of the drive device,

FIG. 18 for the embodiment of the drive device of FIG. 14, a representation of the course of displacements or displacement amplitudes of a second end of the second actuator and of a second contact surface section in each case over time due to a control of the first and second actuator device according to the invention,

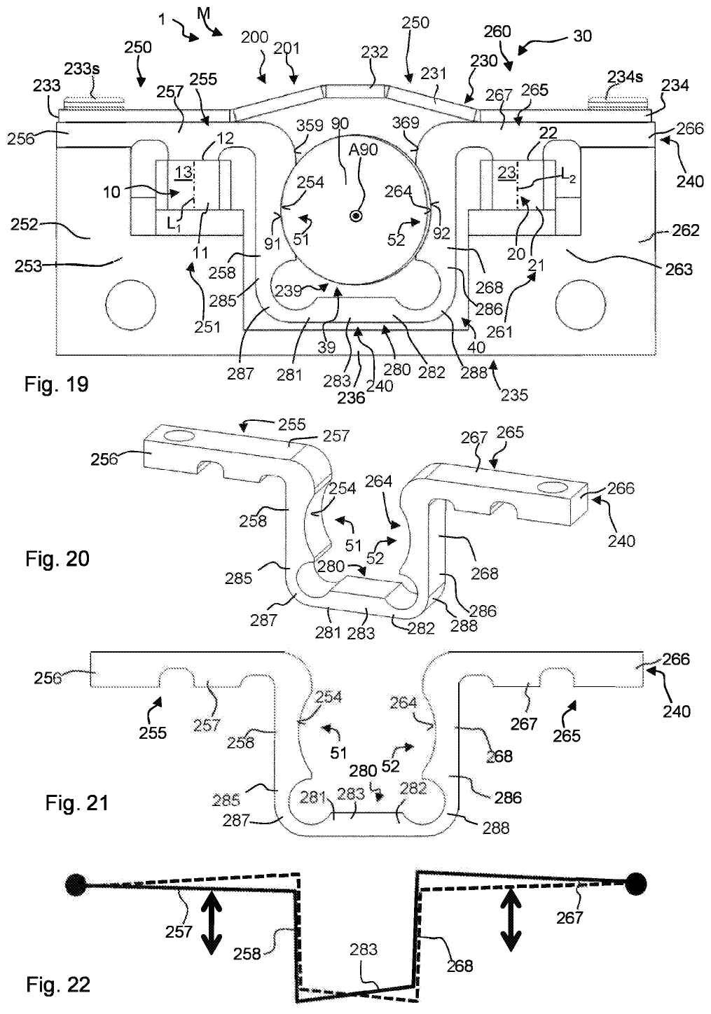

FIG. 19 a side view of a further variant of the embodiments of the drive device of FIGS. 10 and 14, whereby the side view is in the direction of the longitudinal axis of the spindle,

FIG. 20 is a perspective view of the clamping arrangement of the embodiment shown in FIG. 19,

FIG. 21 is a side view of the clamping arrangement shown in FIG. 20,

FIG. 22 is a schematic side view of the clamping arrangement shown in FIGS. 20 and 21, with a solid line showing a deformation state in a first direction and a dashed line showing a deformation state in a second direction, which is opposite to the first direction,

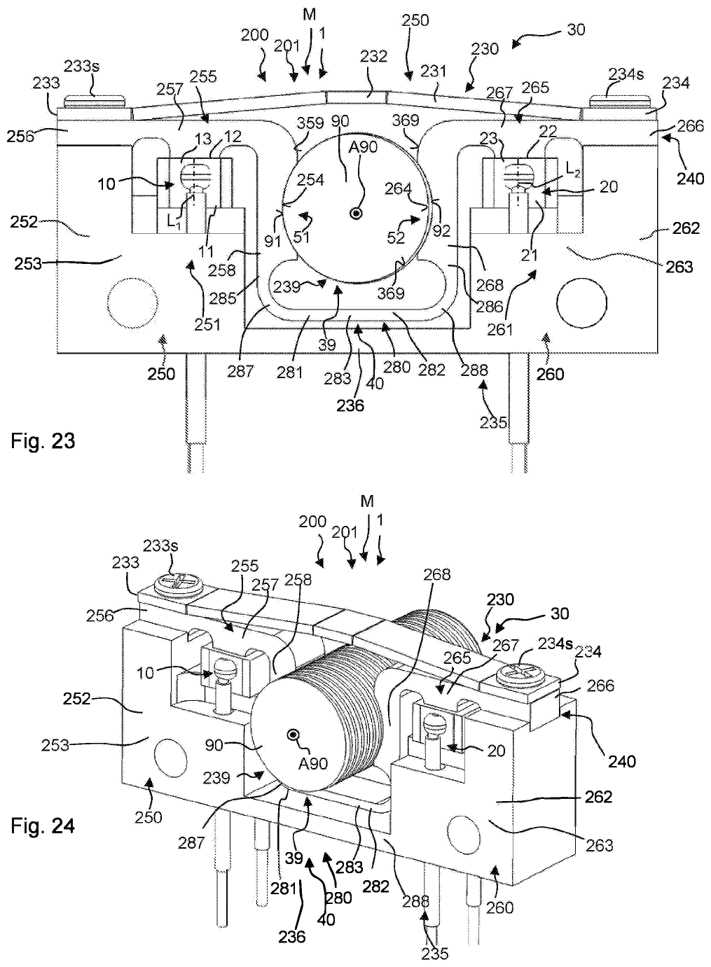

FIG. 23 a side view of a further variant of the embodiments of the drive device of FIG. 19, whereby additional electrical connection devices are shown compared to the illustration of FIG. 19,

FIG. 24 is a perspective view of the embodiments of the drive device of FIG. 19 with the electrical connection devices,

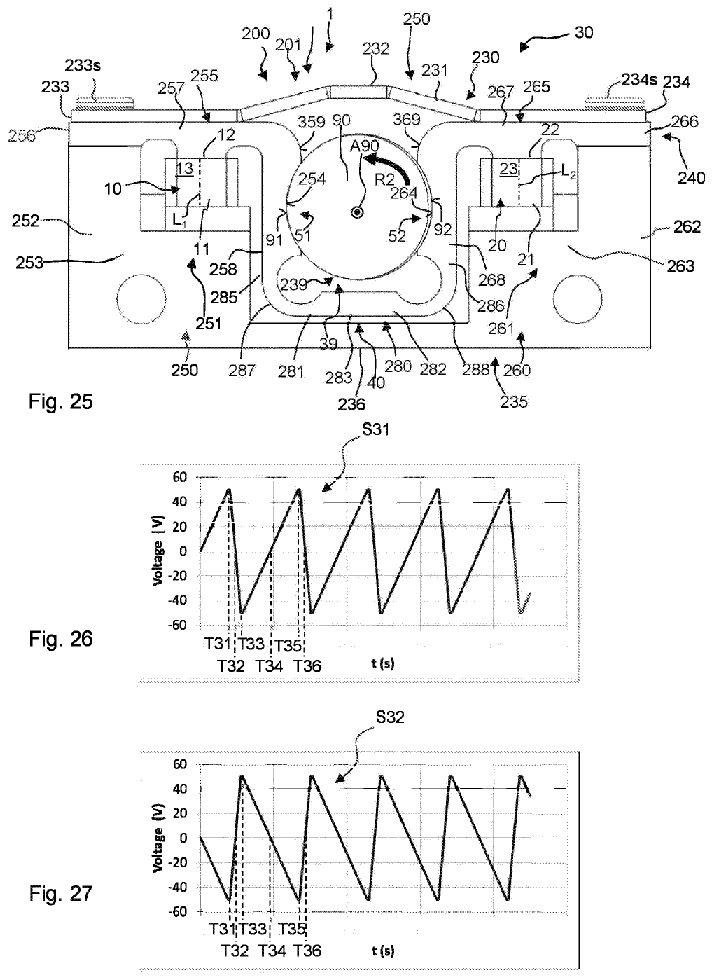

FIG. 25 is a side view of the design of the drive device shown in FIG. 23, in which the direction of travel of the spindle is indicated by an arrow,

FIG. 26 an illustration of an exemplary first electrical control signal for activating the first actuator device of the embodiment of the drive device of FIG. 23,

FIG. 27 an illustration of an exemplary second electrical drive signal for activating the second actuator device of the embodiment of the drive device of FIG. 23 at the drive signal shown in FIG. 26, wherein the spindle is driven in the actuating direction shown in FIG. 25 with the first drive signal and simultaneously with the second drive signal,

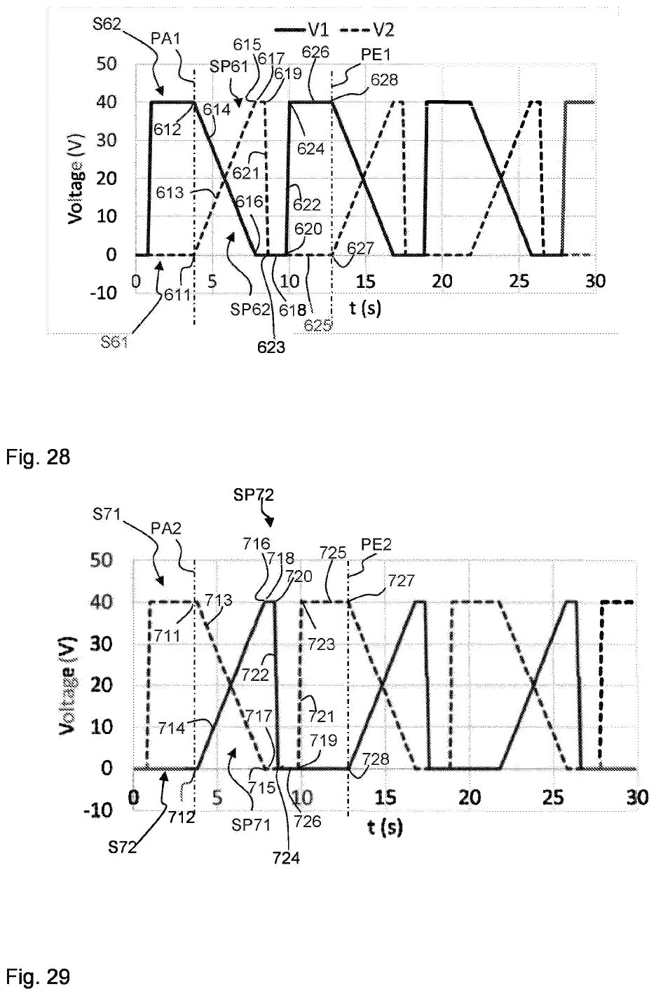

FIG. 28 a representation of a control of a drive device or a drive motor with two actuator devices, wherein in FIG. 28 two electrical control signals for activating the two actuator devices are shown as an example, wherein the control can be used in particular as control of a first actuator device and a second actuator device according to one of the embodiments of the drive device or the drive motor described herein, wherein in the event that the control of FIG. 28 is applied to a drive device according to FIG. 10 or FIG. 19, the spindle is driven clockwise in the direction of view of the drawing plane of the respective representations,

FIG. 29 is a representation of a control of a drive device or a drive motor with two actuator devices according to FIG. 28, whereby in the event that the control of FIG. 28 is applied to a drive device according to FIG. 10 or FIG. 19, the spindle is driven counterclockwise in the direction of view of the drawing plane of the respective representations,

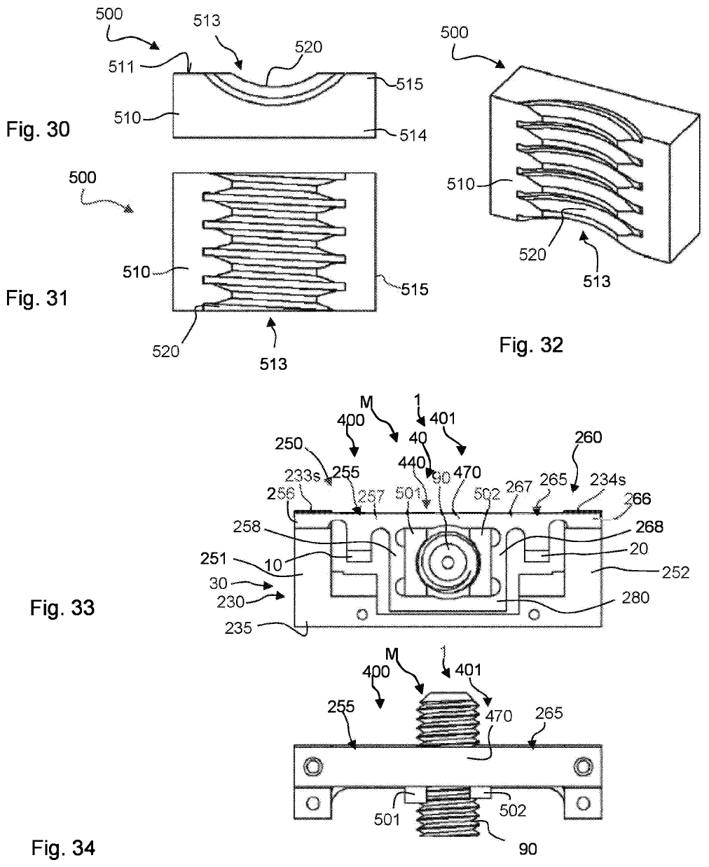

FIG. 30 a plan view of an insert piece which can be inserted into the respective actuating component structure on an outer side of an actuating component structure facing the spindle space and, in particular, of a frame device or an actuating component or actuator functional part of a drive device according to the invention, the insert piece being made of a ceramic material,

FIG. 31 is a side view of the insert shown in FIG. 30,

FIG. 32 is a perspective view of the insert shown in FIG. 30,

FIG. 33 is a side view of a drive device which is a variant of the drive device of FIG. 23, wherein an insert piece of FIG. 30 is inserted into each of two actuating sections of an actuating component or actuator functional part,

FIG. 34 is a top view of the drive device of FIG. 33,

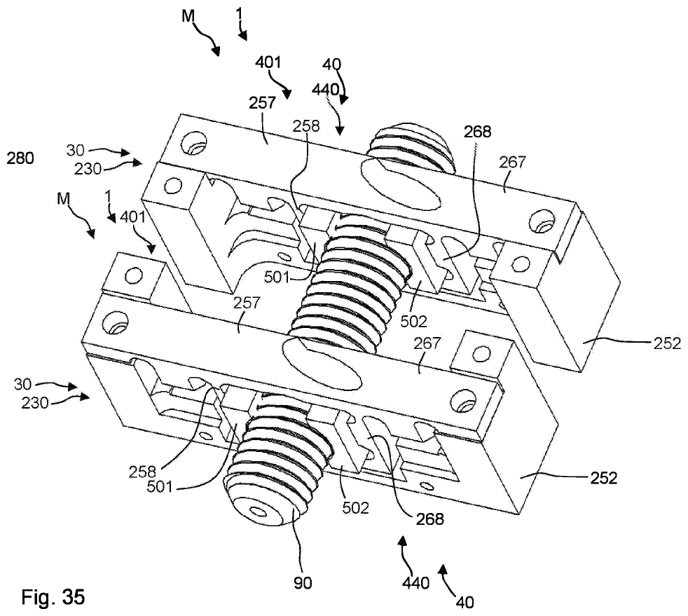

FIG. 35 a perspective view of an arrangement of two drive devices of FIG. 33, wherein the drive devices individually or in combination can drive a spindle which is received by the inserts.

The embodiments of the drive device 1 according to the invention and in particular the embodiment of the drive device 1 shown in FIG. 1 each comprise a frame device 30, a first actuator device 10, a second actuator device 20 and an actuating device 40. In the embodiment shown in FIG. 1, the actuating device 40 is defined by sections 131, 132, 133 of the housing.

The actuating device is also generally referred to herein as the actuating component structure.

An actuator device 10, 20 provided with respect to the invention herein may generally comprise or consist of an actuator 13 or 23. For example, the actuator device 10, 20 may comprise the actuator 13 or 23 and an at least partial external coating of the actuator 13 or 23. In addition, alternatively or additionally, the actuator device 10, 20 may comprise the actuator with or without at least partial external coating and a housing surrounding the actuator 13 or 23 with or without at least partial external coating. Such a housing can be designed in such a way that it pretensions or additionally pretensions the actuator 13, 23.

The actuator 13, 23 is a piezo actuator, i.e. an actuator 13, 23 made of piezoelectric and in particular piezoceramic material. Actuators made of another electromechanical material are also conceivable. In general, any form of actuator is conceivable, for example hydraulically or pneumatically operated actuators, or actuators made of a shape memory material.

The drive device 1 is designed to drive a spindle 90 with a spindle axis A90. To accommodate the spindle 90, the drive device 2 comprises a spindle chamber 39 which extends along a longitudinal axis of the spindle chamber. For this purpose, the embodiments of the drive device 1 according to the invention comprise:
the first actuator device 10 with a first end 11, with a second end 12 and with a first actuator 13, the extension of which can be reversibly changed when actuated along a first actuator axis L₁, wherein the first end 11 and the second end 12 are oriented in opposite directions to one another with respect to the first actuator axis L₁ and wherein the first actuator axis L₁ extends transversely to the spindle axis A90 of a spindle 90,
the second actuator device 20 with a first end 21, with a second end 22 and with a second actuator 23, the extension of which can be reversibly changed along a second actuator axis L₂ when electrically actuated, wherein the first end 21 and the
second end 22 are oriented in opposite directions to one another with respect to the first actuator axis L₁ and wherein the first actuator axis L₁ and the second actuator
axis L₂ extend along one another,
the actuating device 40 and
the frame device 30, which provides a spindle chamber 39 for receiving the spindle 90.

Here, either the first ends (11, 21) or the second ends (21, 22) can be defined as actuating ends and the respective other ends of the actuator devices (10, 210, 20, 220) as reference ends.

In each embodiment of the drive device according to the invention, the frame device 30 can be realized as an integral, i.e. coherent, dimensionally stable component. The frame device 30 can also be manufactured as a single piece, i.e. as a continuous structure, e.g. as a cast part. The frame device 30 can also be manufactured or assembled from several components that are attached to one another.

In each embodiment of the drive device according to the invention, the actuator axes L₁, L₂ or at least one of the actuator axes L₁, L₂ can run transversely to the spindle axis A90 of the spindle 90 and, in particular, perpendicular to the spindle axis A90. The first actuator axis L₁ and the second actuator axis L₂ can be located in a straight plane or run along a straight plane that is defined by the spindle axis A90 as its surface normal.

In each embodiment of the drive device 1 according to the invention or in any embodiment of the drive motor M, it can be provided that the arrangement comprising the frame device 30 and the actuating device 40 comprises a surface area with at least two contact surface sections 51, 52, which each extend at least in a section along the direction of the first actuator axis L₁ or the second actuator axis L₂ and, viewed in the direction of the longitudinal axis of the spindle chamber, form surface areas which are located differently from one another and are intended for contact with two different contact areas 91, 92 of the spindle 90 when the latter is inserted into the drive device 1. The respective current spindle contact areas 91, 92 of the spindle 90 are each a surface section of the spindle surface 90a, the position of which on the spindle surface 90a depends on the rotational position of the spindle 90. The two different spindle contact areas 91, 92 can in particular be arranged opposite each other with respect to the spindle axis A90. In the event that the spindle 90 is rotating, the spindle contact areas 91, 92 are momentary contact areas whose position within the spindle surface 90a is constantly changing.

In any embodiment of the drive device according to the invention, it may be provided that at least one of the at least two surface sections 51, 52 is realized according to one or both of the following alternatives (A1), (A2):
(A1) at least one of the at least two surface sections 51, 52 extends at least in a section along the direction of the first actuator axis L₁,
(A2) at least one of the at least two surface sections 51, 52 extends at least in a section along the direction of the second actuator axis L₂.

In this case, two contact surface sections 51, 52 can be located overlapping each other or not overlapping each other, i.e. next to each other, when viewed in the direction of the longitudinal axis of the spindle space or the spindle axis A90. Alternatively or additionally, it may be provided that the at least two contact surface sections 51, 52 are located in such a way that they comprise points which are opposite one another when viewed along the longitudinal axis of the spindle space or the spindle axis A90.

The two contact surface sections 51, 52 can each be concavely curved when viewed from the spindle space 39. In particular, in each embodiment of the drive device 1 according to the invention, it can be provided that at least two contact surface sections 51, 52 are located such that at least one surface normal at a point or location thereof comprises the direction of a vertical of the first actuator axis L₁ or the second actuator axis L₂ or both actuator axes L₁, L₂. In particular, the vertical of the respective actuator axis lies in a plane that is defined as a surface normal by the longitudinal axis of the spindle chamber or the spindle axis A90. In particular, the surface normal directions of points of at least one area of contact surface sections 51, 52 can define an angular range that contains the direction of a vertical of the first actuator axis L₁ or the second actuator axis L₂ or both actuator axes L₁, L₂.

According to the invention, a drive motor M with a drive device 1 according to an embodiment described herein and a spindle 90 is also provided, wherein the spindle 90 is accommodated in the spindle chamber 39 of the frame device 30. The drive device 1 is provided for driving a spindle 90 with a spindle axis A90. To accommodate the spindle 90, the drive device 2 comprises a spindle chamber 39, which extends along a longitudinal axis of the spindle chamber. The longitudinal axis of the spindle chamber extends in the direction of the spindle axis A90 or along the spindle axis A90. The spindle axis A90 extends transversely to the first actuator axis L₁ or transversely to the second actuator axis L₂ or both transversely to the first actuator axis L₁ and transversely to the second actuator axis L₂. In the design of the drive motor M according to the invention, the at least two contact surface sections 51, 52 are each in contact with one of two different spindle contact areas 91, 92 of the spindle surface 90a of the spindle 90. By actuating the first actuator device 10 and the second actuator device 20, in particular simultaneously, the spindle 90 is driven or moved in at least one of two mutually opposite circumferential directions R1 (FIG. 1), R2 (FIG. 4), which are defined in relation to the longitudinal axis of the spindle chamber or spindle axis A90. Through the rotations of the spindle 90, which are also referred to herein as positioning movements, corresponding spindle output movements are realized in a respective direction, which runs along or in the direction of the spindle axis A90 and depends on the thread of the spindle 90.

In the embodiments of the drive motor M according to the invention, the at least two spindle contact areas 91, 92 form two different surface areas, in particular when viewed in the direction of the longitudinal axis of the spindle chamber or the spindle axis A90. The at least two spindle contact areas 91, 92 can overlap, but not cover each other, particularly when viewed in the direction of the longitudinal axis of the spindle chamber or the spindle axis A90. In particular, the at least two spindle contact areas 91, 92 form two opposing contact areas, at least in a section, especially when viewed in the direction of the longitudinal axis of the spindle chamber or the spindle axis A90.

In each embodiment of the drive device according to the invention, it may be provided that at least one of the at least two spindle contact areas 91, 92 is realized according to one or both of the following alternatives (B1), (B2):
(B1) at least one of the at least two spindle contact areas 91, 92 extends at least in a section along the direction of the first actuator axis L₁,
(B2) at least one of the at least two spindle contact areas 91, 92 extends at least in a section along the direction of the second actuator axis L₂.

The embodiment of the drive motor M shown in FIG. 1 comprises the first actuator device 10 with the first actuator 13 and the second actuator device 20 with the second actuator 23. The first actuator axis L₁ and the second actuator axis L₂ run along each other and, in particular, parallel to each other. The actuator axes L₁, L₂ run transversely and, in particular, perpendicular to the spindle axis A90 of the spindle 90 and to the longitudinal axis of the spindle chamber. The spindle axis A90 runs parallel to the longitudinal axis of the spindle chamber.

The drive device 1 according to the invention shown in FIG. 1 comprises a frame device 130 with a spindle chamber 139 for receiving the spindle 90 and an actuating device 140, which is realized as housing sections 131, 132, 133. An actuating piece 141 is optionally provided, which is also referred to herein as an intermediate piece. This can also be omitted and realized by a component of the housing, e.g. a strut, which in particular projects from the section 133 between the reference ends 12, 22 of the actuator devices 10, 20 and against which the reference ends 12, 22 rest. In this case, the first end 11 of the first actuator device 10 rests against a first actuating piece surface 141a of the actuating piece 141 and the first end 21 of the second actuator device 20 rests against a second actuating piece surface 141b of the actuating piece 141, wherein the first actuating piece surface 141a and the second actuating piece surface 141b are set at least in a section opposite to one another and are oriented along the first actuator axis L₁ and the second actuator axis L₂. As shown, the first actuating piece surface 141a and the second actuating piece surface 141b can extend at least in a section transversely to the first actuator axis L₁ and the second actuator axis L₂.

Further, as shown in FIG. 1, in any of the foregoing embodiments, the frame device 130 may include a first side portion 131, a second side portion 132 extending along the first side portion 131, a first connecting portion 133 and a second connecting portion 134, wherein the first connecting portion 133 and the second connecting portion 134 extend along each other and both connect the first side portion 131 and the second side portion 132, respectively. The second connecting section 134 can also be omitted. The spindle space 139 is located between the actuating piece 141 and the second connecting section 134 and defines a spindle space longitudinal axis. In the event that a spindle 90 is used in the drive device 1, the spindle space longitudinal axis runs parallel to the spindle axis A90 or is identical to the spindle axis A90. Thus, the frame device 130 is designed as a structurally continuous component that completely surrounds the spindle chamber 139, the first actuator device 10, the second actuator device 20 and the actuating piece 141 in the circumferential direction defined by the longitudinal axis of the spindle chamber or as seen in the longitudinal axis of the spindle chamber.

The actuating piece 141 comprises a first contact surface section 151. This is located facing the spindle space 139 and can be a section of an actuating surface 141c of the actuating piece 141, which connects the first actuating piece surface 141a and the second actuating piece surface 141b and is also located at least in a section facing the spindle space 129. The first contact surface section 151 is suitable for being in contact with a respective current first spindle contact area 91 of the spindle surface 90a of the spindle 90 and, in particular, abuts against the spindle surface 90 at least in a section. The first contact surface section 151 can be designed as a straight surface. Alternatively, as shown in FIG. 1, the first contact surface section 151 can be concavely curved as seen from the spindle chamber 139. The curvature of the first contact surface section 151 is formed in the circumferential direction defined with respect to the spindle space longitudinal axis or the spindle axis A90, i.e. extends along the circumferential direction.

The second connecting section 134 comprises a second contact surface section 152. The second contact surface section 152 is suitable for being in contact with a respective current second spindle contact area 92 of the spindle surface 90a of the spindle 90 and, in particular, for abutting against the spindle surface 90 at least in a section. The contact surface section 152 can, as shown in FIG. 1, be concavely curved when viewed from the spindle chamber 139. The curvature of the second contact surface section 152 is formed in the circumferential direction defined with respect to the spindle chamber longitudinal axis or the spindle axis A90, i.e. extends along the circumferential direction.

The first contact surface section 151 and the second contact surface section 152 are arranged opposite one another, at least in a section. Accordingly, the at least two spindle contact areas 91, 92, in particular when viewed in the direction of the longitudinal axis of the spindle chamber or the spindle axis A90, form two opposing contact areas, at least in a section.

One or both of the following components (a), (b) may comprise a threaded profile in these embodiments:
(a) the contact surface section 151 of the actuator 141,
(b) the second contact surface section 152 of the second connecting portion 134.

The first contact surface section 151 and the second contact surface section 152 or one of these two contact surface sections can in particular each be realized as a friction surface section.

In the embodiment of the drive device 101 shown in FIG. 1, the frame device 130 exerts a compressive force on the first actuator device 10 along the first actuator axis L₁ and the second actuator device 20 along the second actuator axis L₂ from two opposite sides in each case. In response to this compressive force, the actuating device 140 moves in a direction transverse to the first actuator axis L₁.

In the embodiments of the drive device 101 or the drive motor M described with reference to FIG. 1, the frame device 130 is designed as described as a structurally continuous and dimensionally stable component. The frame device 130 shown in FIG. 1 is also manufactured as a single piece.

In the embodiments of the drive device 101 or the drive motor M described with reference to FIG. 1, the following pre-tensioning situation can arise with the shape of the frame device 130 as a structurally continuous component which completely surrounds the spindle chamber 139, the first actuator device 10 and the second actuator device 20 in the circumferential direction defined by the longitudinal axis of the spindle chamber:
(V1) a pretension of the actuating piece 141 by the first side section 131 and by the second side section 132, so that the side sections 131, 132 press on the actuating piece 141 located between them;
(V2) a pretension of the second connecting portion 134 and the actuating piece 141 from opposite sides towards the spindle space 139 or towards the spindle space longitudinal axis, and in particular their respective contact surface sections 151, 152, from opposite sides towards the spindle space 139 or towards the spindle space longitudinal axis or towards the spindle 90.

In this way, the frame device 130 is designed as an option in particular such that the arrangement comprising the frame device 130 and the actuating device 40 or the actuating piece 141 resiliently biases the first actuator device 10 along the first actuator axis L₁ and the second actuator device 20 along the second actuator axis L₂ and provides a resilient bias with respect to the spindle space 139.

By correspondingly actuating the first actuator device 10 and the second actuator device 20 or one of the two actuator devices 10, 20 of the drive motor M or 100, a corresponding change in length of at least one of the two actuator devices 10, 20 takes place, which causes a movement of the actuating device 40 or the actuating piece 141 in accordance with the actuation. The movement of the actuating device 40 or the actuating piece 141 takes place in one direction along the first actuator axis L₁ or along the second actuator axis L₂ and, depending on the actuation, is a simple linear movement in only one direction or an oscillating movement that takes place alternately in two opposite directions. The frame device 30 or 130 causes a movement of the actuating device 40 or the actuating piece 141 in one direction along one of the actuator axes L₁, L₂ and the simultaneous interaction between the first contact surface section 152 and the respective current first spindle contact area 91 and also simultaneously a counter-movement of the second connecting section 134 along one of the actuator axes L₁, L₂ along a direction which is opposite to the direction of movement of the actuating device 40 or the actuating piece 141. In this way, the contact surface sections 151, 152 also move in opposite directions to one another and, as a result of the contact of the contact surface sections 151, 152 with the spindle 90, both contact surface sections 151, 152 drive the spindle 90 in the same direction of rotation at one point in time.

In general, in the drive device according to FIG. 1, the frame device 130 is fixed to both actuating ends of the actuator devices 10, 20 and, in particular, is fixed in a rotationally fixed manner. The sections 131, 132, 133 act as an actuating component or actuating component structure, which in each case extends cantilevered over its entire extension between the actuating ends or from the actuating ends of the actuator devices 10, 20 and comprises a contact surface section 152, which in each case extends at least in a section along the direction of the first actuator axis L₁ or the second actuator axis L₂, delimits the spindle space 39 in one section and is provided for contact with a respective spindle surface contact area 92 of the spindle 90 in order to set the spindle 90 in rotation when the first actuator device 10 or the second actuator device 20 or both actuator devices are operated.

FIG. 1 shows an actuating movement of the spindle 90 in the direction of rotation R1 and FIG. 4 shows an actuating movement of the spindle 90 in the direction of rotation R2, which is directed in the opposite direction to the direction of rotation R1.

In order to improve the counter-movement of the second connecting portion 134, it may be provided that, as seen in the spindle space longitudinal axis or the spindle axis A90 and in the longitudinal extension of the first side portion 131 between the first connecting portion 133 and the second connecting portion 134, the first side portion 131 and the second side portion 132, as seen in the direction of the spindle space longitudinal axis or the spindle axis A90, each comprise one or both of the following thickness increases:
(C1) a thickness increase 131c or 132c in the region of the first actuator device 10 or the second actuator device 20, wherein a thickness reduction 131e, 131f or 132e, 132f is formed on both sides in addition to the thickness increase 131c or 132c;
(C2) a thickness increase 131d or 132d in the region between the thickness increase 131c or 132c and the second connecting portion 134, wherein a thickness reduction 131f, 131g or 132f, 132g is formed on both sides in addition to the thickness increase 131d or 132d.

As an alternative to the embodiments of the drive device 101 with pretensioning of the contact surface sections 151, 152 in the direction towards the spindle chamber 139 or the spindle 90, the frame device 130 may also be designed in such a way that the pretensioning (V1) is present, but not the pretensioning (V2), with otherwise any other combination of features described herein.

The actuation of the first actuator device 10 and the second actuator device 20 and the drive of each embodiment of the drive motor M or the spindle 90 according to the invention takes place by applying one or both of the following control signals (D1), (D2) in the form of a voltage signal to the first actuator device 10 or the second actuator device 20:
(D1) applying a first control signal in the form of a first voltage signal to the first actuator device 10 or the first actuator 13;
(D2) applying a second control signal, in each case in the form of a second voltage signal, to the second actuator device 20 or the second actuator 23.

In general, the first actuator device 10 changes its length between a minimum length in the first actuator axis L₁ at a relative minimum of the first voltage signal S1 (e.g. time T1 in FIG. 2) and a maximum length in the first actuator axis L₁ at the relative maximum of the first voltage signal S1 (e.g. time T3 in FIG. 2). In general, the second actuator device 20 also changes its length between a maximum length in the second actuator axis L₂ at a relative maximum of the second voltage signal S2 (e.g. time T1 in FIG. 3) and a minimum length in the second actuator axis L₂ at the relative minimum of the second voltage signal S2 (e.g. time T3 in FIG. 3).

FIGS. 2, 3, 5 and 6 show control signals in the form of voltage signals which can be used to drive embodiments of the drive motor M or 100 according to the invention, but generally any embodiment of the drive motor M according to the invention. Here, voltage signals of FIGS. 2 and 3 are applied to the first actuator device 10 and the second actuator device 20 or the first actuator 13 or the second actuator 23 in order to effect an actuating movement of the spindle 90 in the first direction of rotation R1 (FIG. 1) and voltage signals of FIGS. 5 and 6 are applied to the first actuator device 10 and the second actuator device 20 or the first actuator 13 or the second actuator 23 in order to effect an actuating movement of the spindle 90 in the second direction of rotation R2 (FIG. 4).

To cause an actuating movement of the spindle 90 in the first direction of rotation R1 (FIG. 1) or second direction of rotation R2 (FIG. 4), a time-dependent and periodic first voltage signal S1 with a sawtooth curve is applied to the first actuator device 10 and a time-dependent and periodic second voltage signal S2 with a sawtooth curve is applied to the second actuator device 20, whereby the signals are in phase and in opposite directions over time. In this context, “in-phase” means that the periods of the two signals are identical relative to each other and the zero crossings occur at the same points in time. Deviations of 20% of the respective amount may be given for these specifications. In this context, “in phase opposition” means that in a time period with a rising flank in a first voltage signal S1, S2 there is a descending flank in the respective other voltage signal S2 or S1 and vice versa.

To cause a positioning movement of the spindle 90 in the first direction of rotation R1 (FIG. 1), the gradient of the first voltage signal S11 between a first relative minimum at a time T11 and a next relative maximum at a time T13 is greater according to amount than the gradient of the first voltage signal S1 between this relative maximum at the time T13 and the next relative minimum at the time T15. The gradient between the points in time T11 and T13 can be greater by a factor of at least 1,05 than between the points in time T13 and T15.

At the same time, in order to cause an actuating movement of the spindle 90 in the first direction of rotation R1 (FIG. 1), the gradient of the second voltage signal S12 between a first relative maximum at the time T11 and a relative minimum at the time T13, which follows next in time, is greater according to amount than the gradient of the second voltage signal S12 between this relative minimum at the time T13 and the relative maximum at the time T13, which follows next in time.

Alternatively, a relative maximum of the first voltage signal S11 and a relative minimum of the second voltage signal S12 can occur up to a time difference of up to 20%. With this definition or without this definition, a relative minimum of the first voltage signal S11 and a relative maximum of the second voltage signal S12 can occur up to a time difference of up to 20%.

With these variants of the voltage signals S11, S12, the respective according to amount larger gradient between the times T11 and T13 can be greater by a factor of at least 1,01 and in particular by a factor of at least 1,10 than between the times T3 and T5.

The first voltage signal S1 and the second voltage signal S12 can also have other signal shapes simultaneously or independently of each other. Instead of the sawtooth profile shown in FIGS. 2, 3, 4 and 5, the first voltage signal S1 and the second voltage signal S12 can have a sinusoidal or trapezoidal shape. For all voltage signals S11, S12 that can be used according to the invention, at least one relative maximum and at least one relative minimum or one of these extremes can also be constant over a certain period of time, i.e. plateau-shaped.

In general, the first voltage signal S11 and the second voltage signal S12 are each periodic and, between two relative extremes that are adjacent to each other, comprise a section with a gradient that is greater according to amount than the largest gradient according to amount that occurs between two relative extremes that are adjacent to each other and precede or follow the aforementioned extremes in time. The respective pairs of relative extrema can be directly adjacent in time. However, the respective pairs of relative extrema do not comprise to be directly adjacent in time, but several pairs of extrema with a greater gradient according to amount, preferably with the same gradient sign, but also with different gradient signs, can also directly follow one another, before or after a pair of relative extrema with a smaller gradient according to amount.

In the context of the waveforms of the first voltage signal S11 and the second voltage signal S12, “greater gradient according to amount” herein means a gradient at which at least intermittent slippage occurs between the first contact surface section 51 and the first spindle contact area 91 in contact therewith and between the second contact surface section 52 and the second spindle contact area 92 in contact therewith, since the movement of the contact surface sections 51, 52 does not overcome the inertia of the spindle 90 or overcomes it less than the movements of the contact surface sections 51, 52 in a section with a “smaller gradient according to amount” due to the respective given coefficients of friction relative to the respective spindle contact area 91, 92.

FIG. 9 shows a variant of the embodiments of the drive motor M, 100 according to the invention described with reference to FIG. 1. Here, the actuating surface 141c of the actuating piece 141 is generally concave when viewed from the spindle chamber 139. The first contact surface section 151 is a portion or abutment point of the actuating surface 141c which is in contact with the first spindle contact area 91 of the spindle 90, and is uniformly integrated in the actuating surface 141c in terms of shape. The frame device 130 of FIG. 9 is simplified compared to the embodiment shown in FIG. 1 and is designed, for example, without an increase in thickness in the side sections 131, 132.

A further embodiment of the drive device according to the invention, which is shown in FIG. 10 and designated by the reference sign 201, comprises a frame device 230 with a first tensioning device 231, with a second tensioning device 235, with a first actuator support part 251 and with a second actuator support part 261. The first tensioning device 231 comprises a first end section 233, a second end section 234 and a connecting section 232 connecting these. The second clamping device 235 comprises a first end portion 237, a second end portion 238 and a connecting portion 236 connecting these.

Furthermore, the drive device 201 comprises an actuating device 240. This comprises: a first actuator functional part 255 with a first contact surface section 254 and a second actuator functional part 265 with a second contact surface section 264, wherein the contact surface sections 254, 264 are arranged opposite one another and together form a spindle space 239 between them.

The first actuator device 10 is located between the first actuator support part 251 and the first actuator functional part 255, wherein the first actuator support part 251 and the first actuator functional part 255 each bear directly or indirectly via an intermediate component against opposite ends 11 and 12, respectively, of the first actuator device 10. For example, the first end 11 is in contact with the first actuator support part 251 and the second end 12 is in contact with the first actuator functional part 255. The first actuator support part 251, the first actuator functional part 255 and the first actuator device 10 form a first actuating structure 250.

The second actuator device 20 is located between the second actuator support part 261 and the second actuator functional part 265, wherein the second actuator support part 261 and the second actuator functional part 265 each bear directly or indirectly via an intermediate component against opposite ends 21 and 22 of the second actuator device 20. For example, the first end 21 is in contact with the second actuator support part 261 and the second end 22 is in contact with the second actuator functional part 265. The second actuator support part 261, the second actuator functional part 265 and the second actuator device 20 form a second actuating structure 260.

The contact surface sections 254, 264 can comprise the features of a variant of a contact surface section described herein and, in particular, can be concavely curved when viewed from the spindle space 239. The curvatures are formed in the circumferential direction defined with respect to the spindle axis A90 and are suitable for each of these to lie flat against the spindle surface 90a.

The first actuator support part 251 comprises a first base section 252 and an adjoining first support section 253. The first actuator functional part 255 comprises a first fastening section 256 and a first actuating section 258 and a first connecting section 257 connecting these. The first support portion 253 abuts the first end 11 and the first connecting portion 257 abuts the second end 12 of the first actuator device 10. The first base portion 252 and the first attachment portion 256 are attached to the first end portion 233 of the tensioning device 231 by means of a connecting element 233s. Here, the first actuator support portion 251 and the first actuator functional portion 255 may be configured such that the first support portion 253 exerts a pressure on the first end 11 and the first connecting portion 257 exerts a pressure on the second end 12 to compress the first actuator device 10 from both ends 11, 12 thereof. In a variant of the actuator device 240, the first attachment portion 256 may be omitted and the first connecting portion 257 may be attached to the second end 12. A first actuating section 258 extends from the first connecting section 257 along the first actuator axis L₁. The first actuating section 258 comprises a surface section 259 which is located facing the spindle space 239. The first contact surface section 254 is located in the actuating surface 259. This can generally comprise features that are described herein with reference to other contact surface sections, and in particular can be realized as a friction surface with respect to a surface section that surrounds the actuating surface 259.

Similarly, the second actuator support part 261 comprises a second base section 262 and an adjoining second support section 263. The second actuator functional part 265 comprises a second fastening section 266 and a second actuating section 268 and a second connecting section 267 connecting these. The second support portion 263 abuts the first end 21 and the second connecting portion 267 abuts the second end 22 of the second actuator device 20. The second base portion 262 and the second attachment portion 266 are attached to the second end portion 234 of the tensioning device 231 by means of a connecting element 234s. Here, the second actuator support portion 261 and the second actuator functional portion 265 may be configured such that the second support portion 263 exerts a pressure on the first end 21 and the second connecting portion 267 exerts a pressure on the second end 12 to compress the second actuator device 20 from both ends 21, 22 thereof.

The connecting portions 257, 267 and in particular the actuator functional parts 255, 265, also referred to herein as the actuating component, form the actuating device 140, 240 or the actuating component structure. Optionally, it may be provided that one of the actuator functional parts 255, 265 is not in contact with the spindle.

In the embodiment of FIGS. 10 and 19, the actuating device 240 of the drive device 201 is fixed at both actuating ends of the actuator devices 10, 20, 210, 220 and comprises in each case at least one actuating component 255, 265, which in each case extends cantilevered over its entire extent between the actuating ends or from the actuating ends of the actuator devices 10, 210, 20, 220 and comprises a contact surface section 254, 264, which in each case extends at least in a section along the direction of the first actuator axis L₁ or the second actuator axis L₂, delimits the spindle space 39 in one section and is provided for contact with a respective spindle surface contact area 91, 92 of the spindle 90 in order to set the spindle 90 in rotation when the first actuator device 10, 210 or the second actuator device 20, 220 or both actuator devices 10, 210, 20, 220 are operated.

The actuator support members 251, 261 may be considered parts of the frame device in any embodiment of the drive device described with reference to FIGS. 10, 19, 33.

In a variant of the actuating device 240, the second attachment portion 266 may be omitted and the second connecting portion 267 may be attached to the second end 22. A second actuating section 268 extends from the second connecting section 267 along the second actuator axis L₂. The second actuating section 268 comprises a surface section 269, which is located facing the spindle chamber 239. The second contact surface section 264 is located in the actuating surface 269. This can generally comprise features that are described herein with reference to other contact surface sections, and in particular can be realized as a friction surface with respect to a surface section that surrounds the actuating surface 269.

The surface sections 259, 269 face each other and are opposite each other. Similarly, the contact surface sections 254, 264 face each other and are opposite each other.

The first clamping device 231 connects the first end section 233 and the second end section 234 and is substantially curved between them. The first clamping device 231 can be plate-shaped or bracket-shaped. In particular, the connecting section 232 comprises a curvature in the area that does not abut the first end section 233 and the second end section 234. As shown in FIG. 10, this can be a uniform curvature, so that it does not comprise an inflection point. According to FIG. 10, the curvature is concavely curved as seen from the spindle space 239. Alternatively, the connecting section 232 can also be convexly curved. In this way, the connecting section 232 biases the first actuating section 258 and the second actuating section 268 in a resilient manner from two opposite sides towards the spindle chamber 239 or towards the spindle 90.

Similarly, the optionally provided second clamping device 235 connects the first base portion 252 of the first actuator support part 251 and the second base portion 262 of the second actuator support part 261, with the first end portion 237 being attached to the first base portion 252 and the second end portion 238 being attached to the second base portion 262, for example by means of a connecting element in each case or by means of an interlocking connection. In particular, this arrangement comprising the second clamping device 235, the first base section 252 and the second base section 262 can be realized in such a way that the second clamping device 235 clamps the first base section 252 and the second base section 262 together relative to one another, i.e. exerts forces on the base sections 252, 262 which press them towards one another.

In any embodiment of the drive device 1, 201 according to the invention with all other features otherwise described herein and alternative features, if any, the first clamping device 231 and the second clamping device 235 may be attached to each other and in this way form a circumferential frame device 230. It may be provided that the first actuator support member 251 and the first actuator functional member 255 are spaced apart or attached together to at least one of the clamping devices 231, 235. It can also be provided that the second actuator support part 261 and the second actuator functional part 265 are spaced apart from one another or are fastened together to at least one of the clamping devices 231, 235.

In the embodiments of the drive device 200 described herein, the frame device 230 with the first clamping device 235 and the second clamping device 235 is thus designed as a structurally continuous component which completely surrounds the spindle chamber 239, the first actuator device 10 and the second actuator device 20 in the circumferential direction defined by the longitudinal axis of the spindle chamber.

In particular, it can be advantageous if the first base section 252 and the first actuator support section 253 as well as the second base section 262 and the second actuator support section 263 each form a lever. This causes the forces exerted by the second clamping device 235,
(D1) that the first actuator support portion 253 presses the first actuator device 10 against the first actuator functional part 255 or the first contact section 257, thereby biasing the first actuator device 10 and the first actuator functional part 255 with the first actuating section 258;
(D2) that the second actuator support portion 263 presses the second actuator device 20 against the second actuator functional part 265 or the second contact section 267, thereby biasing the second actuator device 20 and the second actuator functional part 265 with the second actuating section 268.

In the embodiment of the actuator device 1, 201 according to the invention shown in FIG. 10, the connecting portion 257 of the first actuator functional part 255, which abuts against the second end 12 of the first actuator device 10, extends laterally towards the spindle space 239 and away from the first attachment portion 256 of the first actuator support part 251. Also, in the embodiment of FIG. 10, the first actuating section 258 extends from the connecting portion 257 along the first actuator axis L₁ and the first contact surface section 254 extends at least in a section along the first actuator axis L₁. Furthermore, the connecting portion 267 of the second actuator functional part 265, which abuts the second end 12 of the second actuator device 20, extends laterally towards the spindle space 239 and away from the second attachment portion 266 of the second actuator support part 261. Also, in the embodiment of FIG. 10, the second actuating section 268 extends from the connecting portion 267 along the second actuator axis L₂ and the second contact surface section 264 extends at least in a section along the second actuator axis L₂. Thus, the first and second contact surface sections 254, 264 form surface areas that are located differently from one another when viewed in the direction of the spindle space longitudinal axis. Likewise, the surface normal directions of points of at least one region of contact surface sections 254, 264 define an angular region which contains the direction of a vertical of the first actuator axis L₁ or the second actuator axis L₂ or both actuator axes L₁, L₂.

In the embodiment of the drive device 1, 201 according to the invention as shown in FIG. 10, the first actuating section 258 and the second actuating section 268 are each designed as a free end of the first fastening section 256 or of the second fastening section 266, which is only mounted fixedly in terms of movement on the respective connecting section 257 or 267 or is connected to the respective connecting section 257 or 267. In particular, the first fastening section 256 and the second fastening section 266 can be resiliently mounted on the respective connecting section 257 or 267. As a result of the aforementioned features (D1), (D2), the first actuating section 258 and the second actuating section 268 are thus each pressed resiliently against the spindle 90 in order to optimize the driving of the spindle 90.

As an alternative to these embodiments, the actuator device 1, 201 according to the invention can also be realized in such a way that the actuating sections 258, 268 are mounted on the respective actuator support part 251 or 261, so that the respective contact surface section 254, 264, depending on the design of the actuating sections 258 and 268, presses less or not resiliently against the spindle 90.

As shown in FIG. 10, the second clamping device 235 can be curved or substantially curved in the region between the first end section 237 and the second end section 238. In particular, the connecting section 236 may be curved or substantially curved. Irrespective of this, the second clamping device 235 can comprise an overall plate-shaped or bracket-shaped design. In particular, the connecting section 236 comprises a curvature in the area that does not abut the first end section 237 and the second end section 238. As shown in FIG. 10, this can be a uniform curvature, so that it does not comprise an inflection point. According to FIG. 10, the curvature is concavely curved when viewed from the spindle chamber 239. Alternatively, the connecting section 236 can also be convexly curved. In this way, the connecting section 236 biases the first actuating section 258 and the second actuating section 268 in a resilient manner from two opposite sides towards the spindle chamber 239 or towards the spindle 90.

An actuation of at least one of the actuator devices 10, 20 of the drive motor 200 according to FIG. 10 causes, as in the embodiments described above, a relative movement of the first contact surface section 254 along the first actuator axis L₁ or of the second contact surface section 264 along the second actuator axis L₂ or both of these relative movements. Due to the contact of the contact surface sections 254, 264 with the spindle surface 90a, at least one of the two contact surface sections 254, 264 drives the spindle 90 in a predetermined direction of rotation controlled in accordance with the control signals. In the case in which only one of the actuator devices 10, 20 is actuated, only that contact surface section 254 or 264 drives the spindle 90 which is functionally connected to the respectively actuated actuator device 10 or 20. When the actuator devices 10, 20 are simultaneously actuated in opposite directions, the contact surface sections 254, 264 drive the spindle 90 in a time interval in the same direction of rotation, corresponding to the circumferential direction in which the contact surface sections 254 and 264 move the first spindle contact area 91 and the second spindle contact area 92.

FIG. 14 shows a variant according to the invention of the embodiments of the drive motor M or 200 according to the invention described herein with reference to FIG. 10. The embodiment of the drive motor 200 according to the invention shown in FIG. 14 shows the features described with reference to FIG. 10. Since the features of this embodiment comprise the same or similar functions as the features of the drive motor 200 shown in FIG. 14, the same reference signs as in FIG. 10 are used for the corresponding features in FIG. 14.

In contrast to the embodiments of the drive motor 200 according to the invention shown in FIG. 10, the drive motor 200 of FIG. 14 comprises connecting sections 232 and 236 which are convexly curved as seen from the spindle space 239.

In addition, in contrast to the embodiment of the drive motor M or 200 according to the invention shown in FIG. 10, in the embodiment of the drive motor M or 200 according to the invention shown in FIG. 14, the first actuator support parts 251, 261 are each formed in a block-like manner.

FIGS. 16 and 17 use a simplified finite element model of the embodiment of the drive device of FIG. 14 to show a first deformation state and a second deformation state when the drive device is controlled accordingly. The first deformation state and the second deformation state can each be an extreme deformation state.

FIG. 18 shows a representation of the time course of the deformation of the second end 22 of the second actuator 23, calculated or simulated with the aid of the finite element model according to FIGS. 16 and 17, and the displacement or displacement amplitude of the second contact surface section 264 caused thereby as a reaction due to a corresponding periodic actuation of the first actuator 13 and the second actuator 23. It can be seen from the curves that a relatively small deformation of the second end 22 of the second actuator 23 causes a larger displacement or displacement amplitude of the second contact surface section 264, which can in particular be greater by a factor of 1.1 or by a factor of 1.2 than the respective associated movement of the second end 22 of the second actuator 23. This also applies analogously to the deformation of the first end 21 of the first actuator 13 and the displacement or displacement amplitude of the first contact surface section 254.

FIG. 19 shows a variant of the embodiment of the drive motor M or 200 according to the invention shown in FIG. 14, whereby the same reference signs as in FIG. 14 are used for the corresponding features in FIG. 19.

In contrast to the embodiments of the drive motor 200 according to the invention shown in FIG. 10, here the actuating device 240 is designed in one piece and comprises a coupling section 280 for this purpose. The coupling section 280 comprises a first end section 281, a second end section 282 and a connecting section 283, which connects the first end section 281 and the second end section 282 to one another. The first end portion 281 is connected to an outer end portion 285 of the first actuating section 258, as seen from the first connecting portion 257 or, as seen from the first clamping device 231, via a first transition portion 287, in particular in a dimensionally stable or resilient manner. The second end section 282 is connected to an outer end section 286 of the second actuating section 268, as seen from the second connecting section 267 or, as seen from the first clamping device 231, via a second transition section 288, in particular in a dimensionally stable manner. In this way, the spindle 90 is located between the connecting section 283 and the first clamping device 231.

As shown in FIG. 19, the cross-sections of the transition sections 287, 288 are reduced relative to the actuating sections 258, 268 and their end sections 285, 286 and relative to the connecting section 283 of the coupling section 280 when viewed along the longitudinal axis of the spindle space or the spindle axis A90. In the embodiment of the drive motor 200 shown in FIG. 19, this results in a resilient connection of the connecting section 283 to the first actuating section 258 and the second actuating section 268.

As shown in FIG. 19, the second clamping device 236 can be designed to be dimensionally stable so that it does not deform or deforms only insignificantly when the actuators 13, 23 are operated. FIG. 22 shows that a resilient pretensioning of the actuating sections 258, 268 against the spindle 90 is achieved by the one-piece design of the 240. However, this is only optional. Thus, it is also achieved that the arrangement of the frame device 230 and the actuating device 240 resiliently biases the first actuator device 10 along the first actuator axis L₁ and the second actuator device 20 along the second actuator axis L₂ and thereby provides a resilient bias of the actuating device 240 in the direction of the spindle chamber 239.

In the embodiments of the drive motor 200 according to the invention described with reference to FIG. 10, it may be provided that one of the actuating sections 258 or 268 is not in contact with the spindle 90 and accordingly does not comprise a contact surface section 254 or 2564.

FIGS. 26 and 27 show voltage signals S31, S32 with which embodiments of the drive motor 200 described with reference to FIG. 19 can be actuated and positioning movements of the spindle 90 can be executed. The times T31, T32, T33, T34, T35, T36 indicated therein are analogous to the times T21, T22, T23, T24, T25, T26 of FIGS. 5 and 6.

In the following, a further method for driving a spindle 90 comprising a spindle axis A90 which is arranged in a spindle chamber 39 of a drive motor with two actuator devices which can actuate an actuating component structure in order to drive the spindle is described. The drive motor may be realized according to an embodiment of a drive motor described herein or otherwise. This method is thus generally applicable to a drive motor with two actuator devices and with an actuating component structure, wherein the actuating component structure drives the spindle according to the stick-slip principle when the actuating component structure is actuated with drive signals according to the method as shown in FIGS. 28, 29.

By way of example, FIGS. 28 and 29 show the time sequences of two control signals in each case in the form of voltage signals of this embodiment of the method according to the invention. In each of FIGS. 28 and 29, two control signals are shown which are supplied simultaneously to the respective actuator devices. In each of FIGS. 28 and 29, the solid line is a control signal which is supplied to a first actuator device V1, and the dashed line is a control signal which is supplied to a second actuator device V2 of the same drive device. In particular, the first actuator device can be, for example, the first actuator device 10 according to one of the embodiments of the drive device 1 according to the invention described herein and the second actuator device can be, for example, the second actuator device 10 of the same embodiment of the drive device according to the invention.

The representation of FIG. 28 shows two control signals S61, S62, wherein a first control signal S61, which is drawn with a dashed line, is supplied to a first actuator device of the respective drive device and a second control signal S62, which is drawn with a solid line, is supplied to a second actuator device of the respective drive device. The control signals S61, S62. Each control signal S61, S62 represents at least one signal pulse section SP61 or SP62 and can, as shown, be composed of a temporal sequence of several signal pulse sections. As an example, in FIG. 28 a single signal pulse section is delimited by two time limits PA1, PA2, which are each represented by a dotted line. The combination of the at least one signal pulse section SP61 or the at least one signal pulse section SP71 causes the controlled actuator devices of the drive motor to drive the spindle in a first direction of rotation. Applied to the embodiments of the drive motor M according to the invention of FIG. 10 or of FIG. 19 or of FIG. 33, the spindle is driven clockwise in the direction of view of the drawing plane of the figure representations of these figures.

In detail, the course of the drive signal S61 in a respective signal pulse section SP61 is as follows:
(K61) At signal point 611, the first actuator device is in a contracted state, i.e. it comprises a relatively small linear extension. A rising signal flank 613 with a positive gradient value extends from this signal point. The magnitude of this gradient value is according to amount below a maximum stick gradient value up to which a stick state exists between a first contact surface section of an actuating component structure (in the embodiments of the drive motors described herein, the first contact surface section 51 or 254) and a respective instantaneous first spindle contact area of the spindle. This stick state ends at the signal point 615. At the signal point 615, the first actuator device is in an expanded state, i.e. comprises a relatively large linear expansion. The end of the stick state can generally be defined by the fact that a predetermined maximum stick pitch value is exceeded.
(K62) From this signal point 615, a plateau phase 617, i.e. a signal section with a gradient essentially with the value zero, extends in the further course of time. In general, it can be defined that this plateau phase 617 begins when the gradient value falls below the value of 20 degrees and in particular below the value of 10 degrees. This definition can be generally predetermined for the method described here. This plateau phase 617 ends with the signal point 619.
(K63) At the signal point 619, a falling signal gradient 621 begins with a negative gradient value and a relatively according to amount large gradient in terms of amount, which is greater in amount than the amount of the gradient of the stick rise signal gradient 613. This gradient value lies above a minimum slip gradient value according to amount, from which a slip state exists between the first contact surface section of the actuating component structure and a respective instantaneous first spindle contact area of the spindle. In general, the maximum stick pitch value is according to amount smaller by a factor than the amount of the minimum slip pitch value, whereby it can be defined that this factor is at least 0, 1 or at least 0,2. This slip state ends at signal point 623. At signal point 623, the first actuator device is in a contracted state, i.e. comprises a relatively small linear extension. The end of the slip state can generally be defined by falling below a predetermined minimum slip gradient value.
(K64) A plateau phase 625, i.e. a signal section with a gradient essentially with the value zero, extends from this signal point 623 in the further course of time. In general, it can be defined that this plateau phase 625 begins when the gradient value falls below the value of 20 degrees and in particular below the value of 10 degrees. This plateau phase 625 ends with the signal point 627. The plateau phase 625 is longer in time by a factor than the plateau phase 618 and it can be predetermined in this context that this factor comprises at least the value 1,1 or at least the value 1.5 or at least the value 2. After or with the signal point 627, at least one further signal pulse section SP61 can begin with the determination criteria (K61), (K62), (K63), (K64).

In detail, the course of the drive signal S62 in a respective signal pulse section SP62 is as follows:
(K65) At signal point 612, the second actuator device is in an expanded state, i.e. comprises a relatively large linear expansion. A falling signal flank 614 with a negative gradient value extends from this signal point. The magnitude of this gradient value is according to amount below a maximum stick gradient value up to which a stick state exists between a second contact surface section of an actuating component structure (in the embodiments of the drive motors described herein, the first contact surface section 52 or 264) and a respective instantaneous first spindle contact area of the spindle. This stick state ends at the signal point 616. At the signal point 616, the second actuator device is in a contracted state, and thus comprises a relatively small linear extension. The end of the slip state can generally be defined by the fact that a predetermined maximum stick pitch value is exceeded.
(K66) From this signal point 616, a plateau phase 618, i.e. a signal section with a gradient essentially with the value zero, extends in the further course of time. In general, it can be defined that this plateau phase 618 begins when the gradient value falls below the value of 20 degrees and in particular below the value of 10 degrees. This definition can be generally predetermined for the method described here. This plateau phase 618 ends with the signal point 620.
(K67) At the signal point 620, a rising signal flank 622 begins with a positive gradient value and a relatively large gradient according to amount, which is greater in amount than the amount of the gradient of the falling signal flank 614. In terms of amount, this gradient value is according to amount above a minimum slip gradient value, from which a slip state exists between the first contact surface section of the actuating component structure and a respective instantaneous first spindle contact area of the spindle. In general, the maximum stick pitch value is according to amount smaller by a factor than the amount of the minimum slip pitch value, whereby it can be defined that this factor is at least 0, 1 or at least 0,2. This stick state ends at signal point 624. The end of the slip state can generally be defined by falling below a predetermined minimum slip gradient value.
(K68) From this signal point 624, a plateau phase 626, i.e. a signal section with a gradient essentially with the value zero, extends in the further course of time. In general, it can be defined that this plateau phase 626 begins when the gradient value falls below the value of 20 degrees and in particular below the value of 10 degrees. This plateau phase 626 ends with the signal point 628. The plateau phase 626 is shorter in time by a factor than the plateau phase 625 and it can be predetermined in this context that this factor comprises at least the value 1.1 or at least the value 1.5 or at least the value 2. After or with the signal point 628, at least one further signal pulse section SP62 can begin with the determination criteria (K65), (K66), (K67), (K68).

In detail, the course of the actuation signal S71 in a respective signal pulse section SP71 is as follows:
(K71) At signal point 711, the first actuator device is in an expanded state, i.e. comprises a relatively large linear expansion. A falling signal flank 713 with a negative gradient value extends from this signal point. The gradient value is according to amount below a maximum stick gradient value up to which a stick state exists between a second contact surface section of an actuating component structure (in the embodiments of the drive motors described herein, the first contact surface section 52 or 264) and a respective instantaneous first spindle contact area of the spindle. This stick state ends at the signal point 715. At the signal point 715, the first actuator device is in a contracted state, i.e. comprises a relatively small linear extension. The end of the stick state can generally be defined by the fact that a predetermined minimum stick pitch value is exceeded according to amount.
(K72) From this signal point 715, a plateau phase 717, i.e. a signal section with a gradient essentially with the value zero, extends in the further course of time. In general, it can be defined that this plateau phase 717 begins when the gradient value falls below the value of 20 degrees and in particular below the value of 10 degrees. This definition can be generally predetermined for the method described here. This plateau phase 717 ends with the signal point 719.
(K73) At the signal point 719, a rising signal flank 721 begins with a positive gradient value and a relatively large gradient according to amount, which is greater in amount than the amount of the gradient of the rising signal flank 713. This gradient value is above a minimum slip gradient value according to amount, from which a slip state exists between the first contact surface section of the actuating component structure and a respective instantaneous first spindle contact area of the spindle. In general, the maximum stick pitch value is according to amount smaller by a factor than the amount of the minimum slip pitch value, whereby it can be defined that this factor is at least 0.1 or at least 0.2. This slip state ends at signal point 723. At signal point 723, the first actuator device is in an expanded state, i.e. comprises a relatively large linear extension. The end of the slip state can generally be defined by falling below a predetermined minimum slip gradient value.
(K74) From this signal point 723, a plateau phase 725, i.e. a signal section with a gradient essentially with the value zero, extends in the further course of time. In general, it can be defined that this plateau phase 725 begins when the gradient value falls below the value of 20 degrees and in particular below the value of 10 degrees. This plateau phase 725 ends with the signal point 727. After or with the signal point 727, at least one further signal pulse section SP71 with the determination criteria (K71), (K72), (K73), (K74) can begin.

In detail, the course of the drive signal S72 in a respective signal pulse section SP72 is as follows:
(K75) At signal point 712, the second actuator device is in a contracted state, i.e. comprises a relatively small linear extension. A rising signal flank 714 with a positive gradient value extends from this signal point. This gradient value is according to amount below a maximum stick gradient value up to which a stick state exists between a second contact surface section of an actuating component structure (in the embodiments of the drive motors described herein, the first contact surface section 52 or 264) and a respective instantaneous first spindle contact area of the spindle. This stick state ends at the signal point 716. At the signal point 716, the second actuator device is in an expanded state, i.e. comprises a relatively large linear expansion. The end of the stick state can generally be defined by the fact that a predetermined maximum stick pitch value is exceeded.
(K76) From this signal point 716, a plateau phase 718, i.e. a signal section with a gradient essentially with the value zero, extends in the further course of time. In general, it can be defined that this plateau phase 718 begins when the gradient value falls below the value of 20 degrees and in particular below the value of 10 degrees. This definition can be generally predetermined for the method described here. This plateau phase 718 ends with the signal point 720.
(K77) At the signal point 720, a falling signal flank 722 begins with a negative gradient value and a relatively large gradient according to amount, which is greater according to amount than the amount of the gradient of the rising signal flank 714. This gradient value is above a minimum slip gradient value in terms of amount, from which a slip state exists between the first contact surface section of the actuating component structure and a respective instantaneous first spindle contact area of the spindle. In general, the amount of the minimum slip pitch value is according to amount greater by a factor than the maximum stick pitch value, whereby it can be defined that this factor is at least 0, 1 or at least 0,2. This slip state ends at signal point 724. The end of the slip state can generally be defined by the fact that a predetermined minimum slip gradient value is undershot.
(K78) From this signal point 724, a plateau phase 726, i.e. a signal section with a gradient essentially with the value zero, extends in the further course of time. In general, it can be defined that this plateau phase 726 begins when the gradient value falls below the value of 20 degrees and in particular below the value of 10 degrees. This plateau phase 726 ends with the signal point 728. The plateau phase 726 is longer in time by a factor than the plateau phase 717 and it can be predetermined in this context that this factor comprises at least the value 1.1 or at least the value 1.5 or at least the value 2. After or with the signal point 728, at least one further signal pulse section SP72 can begin with the determination criteria (K75), (K76), (K77), (K78).

The signal pulse sections for a first and a second actuator device for the method according to FIGS. 28, 29 is generally defined in that two actuation signals each comprise a sequence of at least one signal pulse section SP61, SP62 or SP71, SP72, each signal pulse section comprising:
(a) a stick driving section 613, 614, 713, 714, the maximum gradient section of which comprises a gradient which is less than a predetermined maximum stick gradient value, wherein the stick driving sections of the two signal pulse sections occur simultaneously and in antiphase, i.e. a first stick triggering section of the first signal pulse section and a second stick triggering section of the first signal pulse section comprise opposing gradients, i.e. one of the stick triggering sections comprises a positive gradient and another of the stick triggering sections comprises a negative gradient.
(b) This is followed by a plateau phase of varying duration for both signal pulse sections.
(c) The respective plateau phases are each followed by a slip drive section of the two signal pulse sections at mutually different times, their respective sections of smallest gradient comprising a gradient which falls below a predetermined minimum slip gradient value, wherein the stick drive section which had a positive gradient in step (a) comprises a negative gradient in step (c) and wherein the stick drive section which had a negative gradient in step (a) comprises a negative gradient in step (c).
(d) This is followed by a plateau phase of varying duration for both signal pulse sections until a simultaneous end point is reached.

FIGS. 30 to 32 show representations of an insert piece 500 which can be used according to the invention. The insert piece 500 comprises a base body 510 which comprises a concave depression 513 on an outer surface 511. Otherwise, the base body 510 is essentially rectangular in shape, but can also comprise a different shape. The outer side of the concave recess 513 is shaped as a threaded section 520 with several threads. The threaded section 520 represents a section of a thread limited in the direction of contact and is thus suitable for contact with a spindle contact area 91, 92 of the spindle 90. For this purpose, the insert piece 500 is arranged at a corresponding location of an outer side or a recess of the outer side of an actuating component structure 40, 140, 240 or an actuating device or a frame device 30, 130, 230. In addition, the insert piece 500 may be arranged at a corresponding position of the intermediate piece or actuating piece. In this case, the threaded portion 520 is located facing the spindle chamber or the spindle 90.

The insert 500 is made of a ceramic material or comprises a ceramic material. The ceramic material comprises or consists of one or more of the following material components: Alumina ceramic, ZTA (Zirconia Toughened Alumina), ATZ (Alumina Toughened Zirconia).

According to the invention, in the embodiments described herein, the insert piece 500 may be used according to one or more of the following alternatives, for example:
(i) The embodiments described with reference to FIG. 1 may include the insert 500 as an insert in the second connecting portion 134 at a position where the threaded portion 520 abuts a time-varying spindle contact area 91, 92 of the external thread of the spindle 90.
(ii) The embodiments described with reference to FIG. 1 may comprise the insert piece 500 as an insert in the intermediate piece 141 or actuating piece at a position where the thread portion 520 abuts against a time-varying spindle contact area 91, 92 of the external thread of the spindle 90.
(ii) The embodiments described with reference to FIGS. 10 and 19 and 33 may comprise the insert piece 500 as an insert in the actuating sections 258, 268 at a position where the threaded portion 520 abuts against a time-varying spindle contact area 91, 92 of the external thread of the spindle 90. In each case, the threaded portion 520 forms a contact surface section 254, 264.

FIGS. 33 and 34 show a further embodiment of the drive device according to the invention, to which the reference sign 501 is assigned. This embodiment is based on the embodiments of the drive device according to the invention described herein with reference to FIG. 19 or FIG. 10 and comprises two insert pieces 501, 502 according to FIGS. 30 to 32. Otherwise, the drive device 501 can comprise any other feature provided according to the invention of the embodiments described with reference to FIG. 19 or FIG. 10 in a combination of features described herein in each case.

The inserts 501, 502 are inserted in the actuating sections 258, 268 at a point at which the threaded section 520 bears against a time-varying spindle contact area 91, 92 of the external thread of the spindle 90. In each case, the threaded section 520 forms a contact surface section 254, 264.

The embodiment of the drive device according to the invention as shown in FIGS. 33 and 34 comprises actuating sections 258, 268 which comprise corresponding recesses on the side of the actuating sections 258, 268 facing the spindle space. A base body section 514 is inserted in each of these, which is located on an insert side 512 opposite the outer surface 511, so that a base body section 515 with the outer surface 511 protrudes from the visible outer circumference of the actuating sections 258, 268. Alternatively, the insert pieces 501, 502 can also be located completely in the recess, so that the outer surface 511 forms a stepless transition to the outer contour of the respective actuating section 258, 268.

The embodiment of the drive device 401 according to the invention as shown in FIGS. 33 and 34 comprises a component actuating structure 440 realized in one piece. This differs from the component actuating structure 240 of the embodiments of the drive device according to FIG. 19 in particular in that the first connecting portion 257 and the first connecting portion 267 are connected to each other by an actuating connecting portion 470, wherein the actuating connecting portion 470 bridges the spindle space. For this reason, components and parts and combinations of features and their respective variants with the same function, as described in each case with reference to FIG. 19, are assigned the same reference signs and are not described again herein with reference to FIGS. 33 to 35 in order to avoid repetition.

The component actuation structure 440 of the actuator device 401 thus comprises: the first actuating component 255 or first actuator functional part, the second actuating component 265 or second actuator functional part, the actuating connection portion 470 and the coupling section 280.

The insert pieces 501, 502 arranged in the actuating components 255, 265 or actuating sections 258, 268 according to FIG. 33 do not comprise to be provided in this embodiment of the drive device according to FIGS. 33 and 34 and can therefore also be omitted.

A section of the spindle 90 is inserted into the drive device 401, which is shown in FIG. 33, so that a drive motor M is also shown in FIGS. 33 and 34. This is assigned the reference sign 400.

### LIST OF REFERENCE SYMBOLS

1 drive device
10 first actuator device
11 first end of the first actuator 13
12 second end of the first actuator 13
13 first actuator
20 second actuator device
21 first end of the second actuator 23
22 second end of the second actuator 23
23 second actuator
30 frame device
39 spindle room
40 actuating device
51 first contact surface section
52 second contact surface section
90a spindle surface of spindle 90
91 first spindle contact area of the spindle 90
92 second spindle contact area of the spindle 90
100 drive motor
101 drive device
130 frame device
131 first side section
131c thickness enlargement of the first side section 131
131d thickness enlargement of the first side section 131
131e thickness reduction of the first side section 131
131f thickness reduction of the first side section 131
131g thickness reduction of the first side section 131
132 second side section
132c increase in thickness of the second side section 132
132d increase in thickness of the second side section 132
132 thickness reduction of the second side section 132
132f reduction in thickness of the second side section 132
131g thickness reduction of the second side section 132
133 first connecting section
134 second connecting section
139 spindle room
140 actuating device or actuating component structure
141 intermediate piece or actuating piece
141a intermediate piece surface
141b intermediate piece surface
151 first contact surface section of the intermediate piece 141
152 second contact surface section of the frame device 130
153 surface area of the intermediate piece 141
191 friction surface section
200 drive motor
201 drive device
230 Frame device
231 First clamping device
232 connecting section
233 first end section
233s connecting element
234 second end section
234s connecting element
235 second clamping device
236 connecting section
237 first end section
238 second end section
239 spindle room
240 actuating device or actuating component structure
250 first actuating structure
251 first actuator support part
252 first base section of the first actuator support part 251
253 actuator support section of the first actuator support part 251
254 first contact surface section
255 first actuating component or first actuator functional part
256 first fastening section of the first actuator support part 251
257 first connecting section
258 first actuating section
259 actuating surface of the first actuator functional part 255
260 second actuating structure
261 second actuator support part
262 second base section of the second actuator support part 261
263 actuator support section of the second actuator support part 261
264 second contact surface section
265 second actuator component or second actuator functional part
266 second fastening section
267 second connecting section
268 second actuating section
269 actuating surface of the second actuator functional part 265
280 coupling section
281 first end section of the coupling section 280
282 second end section of the coupling section 280
283 connecting section of the coupling section 280
285 outer end portion of the first actuating section 258
286 outer end portion of the second actuating section 268
287 first transition portion between the first end portion 285 and the connecting portion 283
288 second transition portion between the second end portion 286 and the connecting portion 283
400 drive motor
401 drive device
440 component actuating structure
470 actuating connection section
500 drive motor
501 insert piece
502 insert piece
510 base body
511 outer surface
512 insertion page
513 concave recess
514 base body section
515 base body section
520 threaded section
611 signal point
613 rise signal flank
615 signal point
617 plateau phase
619 signal point
621 falling signal flank
623 signal point
625 plateau phase
627 signal point
612 signal point
614 rise signal flank
616 signal point
618 plateau phase
620 signal point
622 falling signal flank
624 signal point
626 plateau phase
628 signal point
A90 spindle axis
L₁ first actuator axis
L₂ second actuator axis
M drive motor
PA1 starting point of a signal pulse segment SP61
PE1 end point of a signal pulse section SP61
PA2 starting point of a signal pulse segment SP62
PE2 end point of a signal pulse section SP62
R1 direction of rotation of the spindle 90
R2 direction of rotation of the spindle 90
S11 voltage signal
S12 voltage signal
SP61 signal pulse section
SP62 signal pulse section
SP71 signal pulse section
SP72 signal pulse section
T11 time of a relative minimum of the voltage signal S11 and a relative maximum of the voltage signal S12
T12 time of a reference value or zero crossing of the voltage signal S11 and S12
T13 time of a relative maximum of the voltage signal S11 and a relative minimum of the voltage signal S12
T14 time of a reference value or zero crossing of the voltage signal S11 and S12
T15 time of a relative minimum of the voltage signal S11 and a relative maximum of the voltage signal S12
T16 time of a reference value or zero crossing of the voltage signal S11 and S12
S21 voltage signal
S22 voltage signal
T21 time of a relative minimum of the voltage signal S21 and a relative maximum of the voltage signal S22
T22 time of a reference value or zero crossing of the voltage signal S21 and S22
T23 time of a relative maximum of the voltage signal S21 and a relative minimum of the voltage signal S22
T24 time of a reference value or zero crossing of the voltage signal S21 and S22
T25 time of a relative minimum of the voltage signal S21 and a relative maximum of the voltage signal S22
T26 time of a reference value or zero crossing of the voltage signal S21 and S22
S31 voltage signal
S32 voltage signal
T31 time of a relative minimum of the voltage signal S31 and a relative maximum of the voltage signal S32
T32 time of a reference value or zero crossing of the voltage signal S31 and S32
T33 time of a relative maximum of the voltage signal S31 and a relative minimum of the voltage signal S32
T34 time of a reference value or zero crossing of the voltage signal S31 and S32
T35 time of a relative minimum of the voltage signal S31 and a relative maximum of the voltage signal S32
T36 time of a reference value or zero crossing of the voltage signal S31 and S32
V1 first actuator device
V2 second actuator device

1. Drive device (1, 101, 201) for driving a spindle (90) with a spindle axis (A90) by actuating the drive device (1), wherein the drive device (2) comprises:
a spindle space (39) for receiving a portion of the spindle (90), wherein the spindle space (39) extends in a longitudinal axis of the spindle space,
a first actuator device (10, 210) with a first end (11), with a second end (12) and with a first actuator (13), the extension of which can be reversibly varied along a first actuator axis L₁ when actuated, wherein the first end (11) and the second end (12) are oriented in opposite directions to one another with respect to the first actuator axis L₁ and wherein the first actuator axis L₁ extends transversely to the spindle axis A90 of a spindle (90),
a second actuator device (20, 220) with a first end (21), with a second end (22) and with a second actuator (23), the extension of which can be reversibly changed along a second actuator axis L₂ when actuated, wherein the first end (21) and the second end (22) are oriented in opposite directions to one another with respect to the second actuator axis L₂ and wherein the first actuator axis L₁ and the second actuator axis L₂ extend along one another, wherein either the first ends (11, 21) or the second ends (21, 22) are actuating ends and the respective other ends of the actuator devices (10, 210, 20, 220) are reference ends,
a frame device (30, 130, 230),
wherein either the frame device (30, 130, 230) or an actuating device (40, 140, 240) of the drive device (1) is fixed to both actuating ends of the actuator devices (10, 20, 210, 220) and comprises at least one actuating component (131, 132, 133, 255, 265) in each case, which extends cantilevered over its entire length between the actuating ends or from the actuating ends of the actuator devices (10, 210, 20, 220) and comprises a contact surface section (152, 254, 264) which extends at least in a section along the direction of the first actuator axis L₁ or the second actuator axis L₂, delimits the spindle space (39) in one section and is provided for contact with a respective spindle surface contact area (91, 92) of the spindle (90) in order to set the spindle (90) in rotation when the first actuator device (10, 210) or the second actuator device (20, 220) or both actuator devices (10, 210, 20, 220) are operated, wherein the compliance of the actuating component (131, 132, 133, 255, 265) is set such that, if a portion of the spindle (90) is located in the spindle space, the expansion or contraction of at least one actuator device causes a component of movement of the at least one contact surface section (152, 254, 264) along the actuator axes (L₁, L₂).

2. Drive device (1, 101, 201) for driving a spindle (90) with a spindle axis A90, wherein the drive device (2) for receiving the spindle (90) comprises a spindle space (39) which extends in a spindle space longitudinal axis, comprising the drive device (2):
a first actuator device (10, 210) with a first end (11), with a second end (12) and with a first actuator (13), the extension of which can be reversibly varied when actuated along a first actuator axis L₁, wherein the first end (11) and the second end (12) are oriented in opposite directions to one another with respect to the first actuator axis L₁ and wherein the first actuator axis L₁ extends transversely to the spindle axis A90 of a spindle (90),
a second actuator device (20, 220) with a first end (21), with a second end (22) and with a second actuator (23), the extension of which can be reversibly varied when actuated along a second actuator axis L₂, wherein the first end (21) and the second end (22) are oriented in opposite directions to one another with respect to the first actuator axis L₁ and wherein the first actuator axis L₁ and the second actuator axis L₂ extend along one another,
an actuating device (40, 140, 240),
a frame device (30, 130, 230),
wherein the arrangement comprising the frame device (30, 130, 230) and the actuating device (40, 140, 240) comprises at least one contact surface section (51, 52, 151, 152, 254, 264), which each extend at least in a section along the direction of the first actuator axis L₁ or the second actuator axis L₂ and form surface regions which are located differently from one another as viewed in the direction of the longitudinal axis of the spindle space, which are provided for contact with two different contact areas (91, 92) of the spindle (90) in order to set the spindle (90) in rotation when the first and second actuator devices (10, 20) are operated,
wherein the first and the second actuator device (10, 20, 210, 220) in each case with the first end (11, 21) contact the frame device (30, 130, 230) and in each case with a second end (12, 22) contact the actuating device (40, 140, 240), and wherein the frame device (30, 130, 230) is designed as a structurally continuous component which completely surrounds the spindle chamber (39), the first actuator device (10) and the second actuator device (20) in the circumferential direction defined by the longitudinal axis of the spindle chamber.

3. Drive device (1, 101, 201) according to claim 2,
wherein the arrangement of the frame device (30, 130, 230) and the actuating device (40, 140, 240) comprises at least one actuating component (131, 132, 133, 255, 265) with a contact surface section (51, 52, 151, 152, 254, 264),
wherein the actuating component (131, 132, 133, 255, 265) is fixed in each case to the actuating ends of the actuator devices (10, 210, 20, 220) and extends cantilevered from these in each case over their entire extension between the respective actuating ends or from respective actuating ends of the actuator devices (10, 210, 20, 220),
wherein the compliance of the actuating component (131, 132, 133, 255, 265) is set such that, if a section of the spindle (90) is located in the spindle space, the actuating component (131, 132, 133, 255, 265) is resiliently biased against the spindle and the expansion or contraction of at least one actuator device causes a component of movement of the at least one contact surface section along the actuator axes (L₁, L₂).

4. Drive device (1, 101, 201) according to one of the preceding claims, wherein the actuator devices (10, 20, 210, 220) each comprise a piezo actuator.

5. Drive device (1, 101, 201) according to one of the preceding claims, wherein the at least two contact surface sections (152, 254, 264) are concavely curved as seen from the spindle space (39) and the curvature is formed along the circumferential direction defined with respect to the longitudinal axis of the spindle space and the contact surface sections (152, 254, 264) are designed so that they lie flat against a circumferential portion of a portion of a spindle (90) located in the longitudinal axis of the spindle space.

6. Drive device (1, 101, 201) according to one of the preceding claims, wherein the arrangement comprising the frame device (30, 130, 230) and the actuating device (40, 140, 240) comprises at least two contact surface sections (51, 52, 151, 152, 254, 264), which each extend at least in a section along the direction of the first actuator axis L₁ or the second actuator axis L₂ and, viewed in the direction of the longitudinal axis of the spindle space, form surface regions which are located differently from one another and are provided for contact with two different contact areas (91, 92) of the spindle (90) in order to set the spindle (90) in rotation when the first and second actuator devices (10, 20) are operated,
wherein the first and the second actuator device (10, 20, 210, 220) in each case with the first end (11, 21) against the frame device (30, 130, 230) and in each case with a second end (12, 22) contact the actuating device (40, 140, 240) or an actuating piece (141), and wherein the frame device (30, 130, 230) is designed as a structurally continuous component, which extends the spindle space (39), the first actuator device (10) and the second actuator device (20) in the direction defined by the longitudinal spindle space, 130, 230) is designed as a structurally continuous component which completely surrounds the spindle chamber (39), the first actuator device (10) and the second actuator device (20) in the circumferential direction defined by the longitudinal axis of the spindle chamber.

7. Drive device (1, 101, 201) according to one of the preceding claims, wherein the at least one contact surface section (152, 254, 264) is a surface section of either an outer layer of the actuating component (131, 132, 133, 255, 265) which is made of a ceramic material, or of an insert piece, which is inserted into the actuating component (131, 132, 133, 255, 265) on an outer side of the actuating component (131, 132, 133, 255, 265) facing the spindle space, or is a surface section of a portion of the actuating component (131, 132, 133, 255, 265) which comprises the contact surface section (152, 254, 264) and is made of a ceramic material or comprises a ceramic material.

8. Drive device (1, 101, 201) according to one of the preceding claims, wherein the ceramic material comprises or consists of one or more of the following material components: aluminum oxide ceramic, ZTA (Zirconia Toughened Alumina), ATZ (Alumina Toughened Zirconia).

9. Drive motor (M, 100, 200) with a drive device (1) according to one of the preceding claims and a spindle (90), which is partially located in the spindle space (39) of the frame device (30) and whose spindle axis A90 extends in the spindle space longitudinal axis and transversely to the first actuator axis L₁ or transversely to the second actuator axis L₂,
wherein each of the at least one contact surface section (152, 254, 264) contacts a respective spindle surface contact area (91, 92) of the spindle (90),
wherein the compliance of the actuating member (131, 132, 133, 255, 265) is set such that, due to the contact between each of the contact surface sections (152, 254, 264) and a respective spindle surface contact area (91, 92), the expansion or contraction of at least one actuator device causes a component of movement of the at least one contact surface section along the actuator axes (L₁, L₂).

10. A drive motor (M, 100, 200) according to any one of the preceding claims, wherein an actuating surface section of the spindle, which comprises the at least one spindle surface contact area (91, 92) of the spindle (90) in the axial movement range of the spindle when the spindle is actuated, is a surface section of either an outer layer of the spindle (90), which is made of a ceramic material, or an insert piece inserted into the spindle (90) at an outer side thereof facing the spindle space, or is a surface section of a portion of the spindle (90), which comprises the actuating surface section of the spindle and is made of a ceramic material or comprises a ceramic material.

11. Drive motor (M) according to one of the preceding claims, wherein the ceramic material comprises or consists of one or more of the following material components:
Alumina ceramic, ZTA (Zirconia Toughened Alumina), ATZ (Alumina Toughened Zirconia).

12. Drive device (101) according to any one of claims 1 to 8,
wherein the first ends (11, 21) are actuating ends and the respective other ends of the actuator devices (10, 210, 20, 220) are reference ends of the actuator devices (10, 210, 20, 220),
wherein the frame device (30) comprises: two side portions (131, 132) fixed to the actuating ends of the first and second actuator devices (10, 20), and a connecting portion (134) connecting the two side portions (131, 132),
wherein the two side sections (131, 132) and the connecting section (134) are realized as an actuating component (131, 132, 133), which in each case extends cantilevered over its entire extent between the actuating ends and comprises a contact surface section (152), which in each case extends at least in a section along the direction of the first actuator axis L₁ or the second actuator axis L₂, delimits the spindle space (39) in one section and is provided for contact with a respective spindle surface contact area (91, 92) of the spindle (90) in order to set the spindle (90) in rotation when the first actuator device (10, 210) or the second actuator device (20, 220) or both actuator devices are operated,
wherein the compliance of the actuating component (131, 132, 133) is set such that, if a portion of the spindle (90) is located in the spindle space, the expansion or contraction of at least one actuator device causes a component of movement of the contact surface section (152) along the actuator axes (L₁, L₂).

13. Drive device (101) according to claim 12,
wherein the first ends (11, 21) of the actuator devices (10, 210, 20, 220) are reference ends which lie opposite one another and are fixed at a constant distance from one another when the drive device (1) is operated,
wherein the drive device (101) comprises an intermediate piece (141),
wherein the second end (12) of the first actuator device (10) contacts a first intermediate piece surface (141a) and the second end (22) of the second actuator device (20) contacts a second intermediate piece surface (141b), wherein the first actuator piece surface (141a) and the second actuator piece surface (141b) are oriented at least in a section opposite one another and transversely to the first actuator axis L₁ and the second actuator axis L₂.

14. Drive device (101) according to claim 13, wherein the intermediate piece (141) comprises a first contact surface section (151) facing the spindle space (139), which in each case extends at least in a section along the direction of the first actuator axis L₁ or the second actuator axis L₂, delimits the spindle space (139) in a section and is provided for contact with a respective spindle surface contact area (91) of the spindle (90) in order to set the spindle (90) in rotation together with the contact surface section (152) of the connecting section (134) when the first actuator device (10, 210) or the second actuator device (20, 220) or both actuator devices (10, 210, 20, 220) are operated.

15. Drive motor (100) comprising a drive device (101) according to any one of the preceding claims 12 to 14 and a spindle (90) comprising a spindle axis A90, wherein each of the at least one contact surface section (151, 152) contacts a respective spindle surface contact area (91, 92) of the spindle (90).

16. Drive device (201) according to any one of claims 1 to 8,
wherein the frame device (230) comprises: a first actuator support part (251), against which the first actuator device (210) rests with its first end (11) as reference end, a second actuator support part (261), against which the second actuator device (220) rests with its first end (21) as reference end,
wherein the drive device (201) comprises: a first actuator functional part (255) with a first actuating section (258), to which the first actuator device (210) is fixed with its second end (12) as actuating end, a second actuator functional part (265) with a second actuating section (268), to which the second actuator device (220) is fixed in a rotationally fixed manner with its second end (22) as actuating end,
wherein the first actuator functional part (255) is realized as a first actuating component and the second actuator functional part (265) is realized as a second actuating component, the actuating component in each case extending cantilevered over its entire extension from the actuating ends of the actuator devices (210, 220) and comprising an contact surface section (254, 264).

17. Drive device (201) according to claim 16, wherein the contact surface sections (254, 264) are each concavely curved from the spindle space (239).

18. Drive device (201) according to claim 10 or 11,
wherein the first actuator functional part (255) comprises the first actuating section (258) and a first contact section (257) connected to the first actuating section (258), and the second actuator functional part (265) comprises the second actuating section (268) and a second contact section (267) connected to the second actuating section (268),
wherein the first and second actuating sections (258, 268) extend along each other.

19. Drive device (201) according to claim 18, wherein the first and second actuating sections (258, 268) each comprise an outer end portion (285, 286) which is located opposite to the first contact section (257) or the second contact section (267), respectively,
wherein the outer end portion (285) of the first actuating section (258) and the outer end portion (386) of the second actuating section (268) are connected to one another via a coupling section (280), so that the first actuator functional part (255), the second actuator functional part (265) and the coupling section (280) are realized as a one-piece actuating component which extends cantilevered over its entire extension between the actuating ends.

20. A drive motor (200, 300) comprising a drive device (201, 301) according to any one of claims 16 to 19 and a spindle (90) comprising a spindle axis A90 received in the spindle space (39), wherein each of the at least one contact surface section (151, 152) contacts a respective spindle surface contact area (91, 92) of the spindle (90).

21. Method of driving a spindle of a drive motor comprising a spindle space for receiving the spindle, two actuator devices and an actuating component structure, the actuator devices being operable to actuate the actuating component structure to drive the spindle according to the stick-slip principle, wherein the actuator devices are each driven by one of two drive signals each comprising a sequence of at least one signal pulse portion (SP61, SP62 or SP71, SP72), each signal pulse portion comprising:
(a) a respective stick driving section (613, 614, 713, 714), the largest pitch section of which comprises a pitch which is less than a predetermined maximum stick pitch value, the stick driving sections of the two signal pulse sections taking place simultaneously and in antiphase,
(b) followed by a plateau phase of varying duration,
(c) followed by a respective slip drive section of the two signal pulse sections at different points in time from one another, their respective minimum gradient sections comprising a gradient which is less than a predetermined minimum slip gradient value, wherein the stick drive section which had a positive gradient in step (a) comprises a negative gradient in step (c) and wherein the stick drive section which had a negative gradient in step (a) comprises a negative gradient in step (c),
(d) followed by a plateau phase of varying duration up to a simultaneous end point for both signal pulse sections.

22. Method for driving a spindle (90) with a spindle axis A90, with a drive device (2), wherein the drive device comprises: two actuator devices (10, 20, 210, 220),
wherein either a frame device (30, 130, 230) or an actuating device (40, 140, 240) of the drive device (1) is fixed to both actuating ends of the actuator devices (10, 20, 210, 220), and in particular is fixed in a rotationally fixed manner, and in each case comprises at least one actuating component (131, 132, 133, 255, 265) which in each case extends cantilevered over its entire length between the actuating ends or from the actuating ends of the actuator devices (10, 210, 20, 220) and comprises a contact surface section (152, 254, 264) which in each case extends at least in a section along the direction of the first actuator axis L₁ or the second actuator axis L₂, delimits the spindle space (39) in one section and is provided for contact with a respective spindle surface contact area (91, 92) of the spindle (90) in order to set the spindle (90) in rotation when the first actuator device (10, 210) or the second actuator device (20, 220) or both actuator devices (10, 210, 20, 220) are operated, wherein the compliance of the actuating component (131, 132, 133, 255, 265) is set such that, if a portion of the spindle (90) is located in the spindle space, the expansion or contraction of at least one actuator device causes a component of movement of the at least one contact surface section along the actuator axes (L1,L2),
wherein the drive device (2) periodically controls the first actuator (13) and the second actuator (23) with a control signal, wherein the gradients of a rising flank and a falling flank of the control signal each comprise a half-period of the same control period with gradients which differ according to amount from one another.

23. Method according to claim 21, wherein the drive device (2) controls the first actuator (13) and the second actuator (23) periodically and in antiphase with a control signal.

24. Method according to claim 22 or 23, wherein the drive device (2) time-delays the flank of the rising flank and the falling flank of a half-period of the drive signals for the first actuator (13) and the second actuator (23), each of which comprises a greater gradient according to amount, with respect to one another.
